(19) United States
(12) Patent Application Publication
(10) Pub. No.: US 2012/0327053 A1
(43) Pub. Date: Dec. 27, 2012

(54) PLASMA DISPLAY DEVICE, PLASMA DISPLAY SYSTEM, DRIVE METHOD FOR PLASMA DISPLAY PANEL, AND CONTROL METHOD FOR SHUTTER GLASSES FOR PLASMA DISPLAY DEVICE

(76) Inventors: Yuya Shiozaki, Osaka (JP); Takahiko Origuchi, Osaka (JP); Hidehiko Shoji, Osaka (JP); Mitsuhiro Ishizuka, Osaka (JP); Shigeo Kigo, Osaka (JP)

(21) Appl. No.: 13/582,953

(22) PCT Filed: Mar. 10, 2011
(86) PCT No.: PCT/JP2011/001395

§ 371 Date: Sep. 5, 2012

(30) Foreign Application Priority Data
Mar. 10, 2010 (JP) 2010052674

(51) Int. Cl. G09G 3/28

(52) U.S. Cl. 345/208; 345/60

(57) ABSTRACT

Sharp contrast is achieved while the driving time in displaying a 3D image on a plasma display panel is shorted. For this purpose, an all-cell initializing subfield for applying up-ramp waveform voltage and down-ramp waveform voltage to a scan electrode in the initializing period is set as the first subfield of one field. The plasma display panel is driven by one of 3D drive and 2D drive. A gradient of at least one of the up-ramp waveform voltage and the down-ramp waveform voltage in the all-cell initializing period during the 3D drive is set to be steeper than a gradient of the one waveform voltage in the all-cell initializing period during the 2D drive. A shutter opening/closing timing signal is generated so that both of a right-eye timing signal and a left-eye timing signal are in the OFF state in the all-cell initializing period during the 3D drive.

### TECHNICAL FIELD

The present invention relates to a plasma display apparatus, a plasma display system, a driving method of a plasma display panel, and a control method of shutter glasses for the plasma display apparatus that allow three-dimensional view using shutter glasses of a three-dimensional image formed of a right-eye image and left-eye image that are alternately displayed on the plasma display panel.

### BACKGROUND ART

An alternating-current surface discharge type panel typical as a plasma display panel (hereinafter referred to as “panel”) has many discharge cells between a front substrate and a rear substrate that are faced to each other. The front substrate has the following elements:
a plurality of display electrode pairs disposed in parallel on a front glass substrate; and
a dielectric layer and a protective layer for covering the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer for covering the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing operation of applying an initializing waveform to each scan electrode, and causing initializing discharge in each discharge cell is performed. Thus, wall charge required for a subsequent address operation is formed in each discharge cell, and a priming particle (an excitation particle for causing discharge) for stably causing address discharge is generated.

In the address period, a scan pulse is sequentially applied to scan electrodes, and an address pulse is selectively applied to data electrodes based on an image signal to be displayed. Thus, address discharge is caused between the scan electrode and the data electrode of the discharge cell to emit light, thereby producing wall charge in the discharge cell (hereinafter, this operation is also collectively referred to as “address”).

In a sustain period, as many sustain pulses as a number based on the luminance weight determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Thus, light is emitted in each discharge cell of the panel at a luminance corresponding to the luminance weight. Thus, light is emitted at a luminance corresponding to the gradation value of an image signal in each discharge cell of the panel, and an image is displayed on the image display region of the panel.

One of important factors for improving the image display quality on the panel is improvement in contrast. As one of subfield methods, a driving method for improving the contrast ratio by minimizing light emission that is not related to the gradation display is disclosed.

In this driving method, in the initializing period of one of a plurality of subfields constituting one field, an initializing operation of causing initializing discharge in all discharge cells is performed. In the initializing periods of other subfields, an initializing operation of selectively causing initializing discharge in the discharge cell that has undergone sustain discharge in the sustain period of the immediately preceding subfield is performed.

The luminance (hereinafter, referred to as “luminance of black level”) in a black displaying region that does not cause sustain discharge is varied by light emission that is not related to the image display, for example light emission caused by initializing discharge. In the above-mentioned driving method, the light emission in the black displaying region is only weak light emission when the initializing operation is performed in all discharge cells. As a result, the luminance of black level can be reduced and an image of sharp contrast can be displayed (for example, Patent Literature 1).

A technology of improving the visibility of black by reducing the luminance of black level in the following process is disclosed (for example, Patent Literature 2). An initializing period is disposed in which an initializing waveform having the following parts is applied to a discharge cell:
a rising part having a gentle inclination part where the voltage gradually increases; and
a falling part having a gentle inclination part where the voltage gradually decreases.
   Immediately before any initializing period of one field, a period for causing weak discharge between a sustain electrode and a scan electrode is disposed in all discharge cells in an image display region.

A method has been studied which displays a three-dimensional (hereinafter referred to as “3D”) image (hereinafter referred to as “3D image”) capable of being viewed three-dimensionally on a panel, and uses a plasma display apparatus as a 3D image display apparatus.

One 3D image is constituted by one right-eye image and one left-eye image. In this plasma display apparatus, when the 3D image is displayed on the panel, the right-eye image and left-eye image are alternately displayed on the panel. A user views the 3D image displayed on the panel using special glasses called shutter glasses (for example, Patent Literature 3). In the shutter glasses, right and left shutters alternately open and close synchronously with each of a field for displaying the right-eye image and a field for displaying the left-eye image.

The shutter glasses have a right-eye shutter and a left-eye shutter. In a period in which the right-eye image is displayed on the panel, the right-eye shutter is opened (visible light is transmitted) and the left-eye shutter is closed (visible light is blocked). In a period in which the left-eye image is displayed, the left-eye shutter is opened and the right-eye shutter is closed. Thus, the user can observe the right-eye image only with the right eye and the left-eye image only with the left eye, and can three-dimensionally view the 3D image displayed on the panel.

One 3D image is constituted by one right-eye image and one left-eye image. When a 3D image is displayed, a half the image displayed on the panel per unit time (for example, one second) is a right-eye image and the remaining half is a left-eye image. Therefore, the number of 3D images displayed on the panel per second is a half the field frequency (the number of fields displayed per second). When the number of images displayed on the panel per unit time is small, fluctuation in image called flicker is apt to be viewed.

When an image other than a 3D image, namely a normal image (hereinafter referred to as “2D image”) having no differentiation between right-eye and left-eye, is displayed on the panel, 60 images are displayed on the panel per second when the field frequency is 60 Hz, for example. Therefore, in order to display as many 3D images as 2D images on the panel per unit time (for example, 60 images per second), the field frequency of the 3D images must be set at twice (for example, 120 Hz) that of the 2D images.

When the field frequency is increased, the period of one field is reduced. For example, when the field frequency is increased from 60 Hz to 120 Hz, the period of one field is reduced from 16.7 msec to 8.3 msec. Therefore, it is desired to reduce the time required for driving the panel when the 3D images are displayed.

### CITATION LIST

### Patent Literature

PLT 1

Unexamined Japanese Patent Publication No. 2000-242224

PLT 2

Unexamined Japanese Patent Publication No. 2004-37883

PLT 3

Unexamined Japanese Patent Publication No. 2000-112428

### SUMMARY OF THE INVENTION

The present invention provides a plasma display apparatus including a panel, a driver circuit, and a control signal generation circuit. The panel has a plurality of discharge cells each of which includes a display electrode pair formed of a scan electrode and a sustain electrode. The driver circuit forms one field using a plurality of subfields each of which has an initializing period, an address period, and a sustain period. The driver circuit sets, as the first subfield of one field, an all-cell initializing subfield having an all-cell initializing period in which an increasing up-ramp waveform voltage and a decreasing down-ramp waveform voltage are applied to a scan electrode in the initializing period. The driver circuit drives the panel by one of 3D drive for displaying a 3D image on the panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and left-eye image signal, and the 2D image is displayed based on a 2D image signal. The control signal generation circuit determines which of the 2D image signal and 3D image signal is input based on the input signal. The control signal generation circuit generates a control signal and a shutter opening/closing timing signal. The control signal is used for controlling the driver circuit in order to display a 2D image or a 3D image on the panel based on the determination result. The shutter opening/closing timing signal includes the following signals:
a right-eye timing signal that becomes ON when a right-eye field of the 3D image is displayed on the panel and becomes OFF when a left-eye field is displayed; and
a left-eye timing signal that becomes ON when a left-eye field of the 3D image is displayed and becomes OFF when a right-eye field is displayed.
   In the driver circuit, the gradient of the up-ramp waveform voltage in the all-cell initializing period during 3D drive is set to be steeper than the gradient of the up-ramp waveform voltage in the all-cell initializing period during 2D drive. The control signal generation circuit generates a shutter opening/closing timing signal where both of the right-eye timing signal and left-eye timing signal are OFF in the all-cell initializing period during 3D drive.

Thus, the plasma display apparatus usable as a 3D image display apparatus can achieve a 3D image of sharp contrast while the time required for driving the panel when a 3D image is displayed is made shorter than that when a 2D image is displayed.

The present invention provides a plasma display apparatus including a panel, a driver circuit, and a control signal generation circuit. The panel has a plurality of discharge cells each of which includes a display electrode pair formed of a scan electrode and a sustain electrode. The driver circuit forms one field using a plurality of subfields each of which has an initializing period, an address period, and a sustain period. The driver circuit sets, as the first subfield of one field, an all-cell initializing subfield having an all-cell initializing period in which an increasing up-ramp waveform voltage and a decreasing down-ramp waveform voltage are applied to a scan electrode in the initializing period. The driver circuit drives the panel by one of 3D drive for displaying a 3D image on the panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and left-eye image signal, and the 2D image is displayed based on a 2D image signal. The control signal generation circuit determines which of the 2D image signal and 3D image signal is input based on the input signal. The control signal generation circuit generates a control signal and a shutter opening/closing timing signal. The control signal is used for controlling the driver circuit in order to display a 2D image or a 3D image on the panel based on the determination result. The shutter opening/closing timing signal includes the following signals:
a right-eye timing signal that becomes ON when a right-eye field of the 3D image is displayed on the panel and becomes OFF when a left⁻eye field is displayed; and
a left-eye timing signal that becomes ON when a left-eye field of the 3D image is displayed and becomes OFF when a right-eye field is displayed.
   In the driver circuit, the gradient of the down-ramp waveform voltage in the all-cell initializing period during 3D drive is set to be steeper than the gradient of the down-ramp waveform voltage in the all-cell initializing period during 2D drive. The control signal generation circuit generates a shutter opening/closing timing signal where both of the right-eye timing signal and left-eye timing signal are OFF in the all-cell initializing period during 3D drive.

Thus, the plasma display apparatus usable as a 3D image display apparatus can achieve a 3D image of sharp contrast while the time required for driving the panel when a 3D image is displayed is made shorter than that when a 2D image is displayed.

The present invention provides a plasma display apparatus including a panel, a driver circuit, and a control signal generation circuit. The panel has a plurality of discharge cells each of which includes a display electrode pair formed of a scan electrode and a sustain electrode. The driver circuit forms one field using a plurality of subfields each of which has an initializing period, an address period, and a sustain period. The driver circuit sets, as the first subfield of one field, an all-cell initializing subfield having an all-cell initializing period in which an increasing up-ramp waveform voltage and a decreasing down-ramp waveform voltage are applied to a scan electrode in the initializing period. The driver circuit drives the panel by one of 3D drive for displaying a 3D image on the panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and left-eye image signal, and the 2D image is displayed based on a 2D image signal. The control signal generation circuit determines which of the 2D image signal and 3D image signal is input based on the input signal. The control signal generation circuit generates a control signal and a shutter opening/closing timing signal. The control signal is used for controlling the driver circuit in order to display a 2D image or a 3D image on the panel based on the determination result. The shutter opening/closing timing signal includes the following signals:
a right-eye timing signal that becomes ON when a right-eye field of the 3D image is displayed on the panel and becomes OFF when a left-eye field is displayed; and
a left-eye timing signal that becomes ON when a left-eye field of the 3D image is displayed and becomes OFF when a right-eye field is displayed.
   In the driver circuit, the gradient of the up-ramp waveform voltage in the all-cell initializing period during 3D drive is set to be steeper than the gradient of the up-ramp waveform voltage in the all-cell initializing period during 2D drive, and the gradient of the down-ramp waveform voltage in the all-cell initializing period during 3D drive is set to be steeper than the gradient of the down-ramp waveform voltage in the all-cell initializing period during 2D drive. The control signal generation circuit generates a shutter opening/closing timing signal where both of the right-eye timing signal and left-eye timing signal are OFF in the all-cell initializing period during 3D drive.

Thus, the plasma display apparatus usable as a 3D image display apparatus can achieve a 3D image of sharp contrast while the time required for driving the panel when a 3D image is displayed is made shorter than that when a 2D image is displayed.

The present invention provides a plasma display system having a plasma display apparatus and shutter glasses. The plasma display apparatus includes a panel, a driver circuit, and a control signal generation circuit. The panel has a plurality of discharge cells each of which includes a display electrode pair formed of a scan electrode and a sustain electrode. The driver circuit forms one field using a plurality of subfields each of which has an initializing period, an address period, and a sustain period. The driver circuit sets, as the first subfield of one field, an all-cell initializing subfield having an all-cell initializing period in which an increasing up-ramp waveform voltage and a decreasing down-ramp waveform voltage are applied to a scan electrode in the initializing period. The driver circuit drives the panel by one of 3D drive for displaying a 3D image on the panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and left-eye image signal, and the 2D image is displayed based on a 2D image signal. The control signal generation circuit determines which of the 2D image signal and 3D image signal is input based on the input signal. The control signal generation circuit generates a control signal and a shutter opening/closing timing signal. The control signal is used for controlling the driver circuit in order to display a 2D image or a 3D image on the panel based on the determination result. The shutter opening/closing timing signal includes the following signals:
a right-eye timing signal that becomes ON when a right-eye field of the 3D image is displayed on the panel and becomes OFF when a left⁻eye field is displayed; and
a left-eye timing signal that becomes ON when a left-eye field of the 3D image is displayed and becomes OFF when a right-eye field is displayed.
   The shutter glasses include a right-eye shutter and a left-eye shutter that can be independently opened or closed and control the opening/closing of the shutters in response to the shutter opening/closing timing signal generated by the control signal generation circuit. In the driver circuit, the gradient of at least one of the up-ramp waveform voltage and the down-ramp waveform voltage in the all-cell initializing period during 3D drive is set to be steeper than the gradient of the one ramp waveform voltage in the all-cell initializing period during 2D drive. The control signal generation circuit generates a shutter opening/closing timing signal where both of the right-eye shutter and left-eye shutter are closed in the all-cell initializing period during 3D drive.

Thus, the plasma display system having the plasma display apparatus usable as a 3D image display apparatus can achieve a 3D image of sharp contrast while the time required for driving the panel when a 3D image is displayed is made shorter than that when a 2D image is displayed.

The present invention provides a driving method of a panel having a plurality of discharge cells each of which includes a display electrode pair formed of a scan electrode and a sustain electrode. In this driving method, one field is formed using a plurality of subfields each of which has an initializing period, an address period, and a sustain period. An all-cell initializing subfield having an all-cell initializing period in which an increasing up-ramp waveform voltage and a decreasing down-ramp waveform voltage are applied to a scan electrode in the initializing period is set as the first subfield of one field. The panel is driven by one of 3D drive for displaying a 3D image on the panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and left-eye image signal, and the 2D image is displayed based on a 2D image signal. The gradient of at least one of the up-ramp waveform voltage and the down-ramp waveform voltage in the all-cell initializing period during 3D drive is set to be steeper than the gradient of the one ramp waveform voltage in the all-cell initializing period during 2D drive.

Thanks to this method, a 3D image of sharp contrast can be achieved while the time required for driving the panel when a 3D image is displayed is made shorter than that when a 2D image is displayed.

The present invention provides a control method of shutter glasses that are used for viewing of an image displayed on a plasma display apparatus and have a right-eye shutter and a left-eye shutter capable of being independently opened or closed. In this control method, the shutter glasses are controlled so that both of the right-eye shutter and left-eye shutter are closed in the all-cell initializing period during 3D drive. The plasma display apparatus includes a panel, a driver circuit, and a control signal generation circuit. The panel has a plurality of discharge cells each of which includes a display electrode pair formed of a scan electrode and a sustain electrode. The driver circuit forms one field using a plurality of subfields each of which has an initializing period, an address period, and a sustain period. The driver circuit sets, as the first subfield of one field, an all-cell initializing subfield having an all-cell initializing period in which an increasing up-ramp waveform voltage and a decreasing down-ramp waveform voltage are applied to a scan electrode in the initializing period. The driver circuit drives the panel by one of 3D drive for displaying a 3D image on the panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and left-eye image signal, and the 2D image is displayed based on a 2D image signal. The control signal generation circuit determines which of the 2D image signal and 3D image signal is input based on the input signal. The control signal generation circuit generates a control signal and a shutter opening/closing timing signal. The control signal is used for controlling the driver circuit in order to display a 2D image or a 3D image on the panel based on the determination result. The shutter opening/closing timing signal includes the following signals:
a right-eye timing signal that becomes ON when a right-eye field of the 3D image is displayed on the panel and becomes OFF when a left-eye field is displayed; and
a left-eye timing signal that becomes ON when a left-eye field of the 3D image is displayed and becomes OFF when a right-eye field is displayed.
   In the driver circuit, the gradient of at least one of the up-ramp waveform voltage and the down-ramp waveform voltage in the all-cell initializing period during 3D drive is set to be steeper than the gradient of the one ramp waveform voltage in the all-cell initializing period during 2D drive.

A user, using the shutter glasses controlled by this control method, watches the plasma display apparatus usable as a 3D image display apparatus where the time required for driving the panel when a 3D image is displayed is made shorter than that when a 2D image is displayed. Thus, the 3D image displayed on the panel can be viewed as an image that has low luminance of black level, sharp contrast, and high image display quality.

### BRIEF DESCRIPTION OF DRAWINGS

FIG. 1 is an exploded perspective view showing a structure of a panel used in a plasma display apparatus in accordance with a first exemplary embodiment of the present invention.

FIG. 2 is an electrode array diagram of the panel used in the plasma display apparatus in accordance with the first exemplary embodiment of the present invention.

FIG. 3 is a diagram for schematically showing circuit blocks of the plasma display apparatus and a plasma display system in accordance with the first exemplary embodiment of the present invention.

FIG. 4 is a diagram for schematically showing a driving voltage waveform to be applied to each electrode of the panel used in the plasma display apparatus in accordance with the first exemplary embodiment of the present invention.

FIG. 5 is a waveform chart for schematically showing a driving voltage waveform applied to each electrode of the panel used in the plasma display apparatus and an opening/closing operation of shutter glasses in accordance with the first exemplary embodiment of the present invention.

FIG. 6 is a diagram for schematically showing a subfield structure and an opened/closed state of a right-eye shutter and a left-eye shutter when a 3D image is displayed on the plasma display apparatus in accordance with the first exemplary embodiment of the present invention.

FIG. 7 is a circuit block diagram for schematically showing one configuration example of a scan electrode driver circuit of the plasma display apparatus in accordance with the first exemplary embodiment of the present invention.

### DESCRIPTION OF EMBODIMENTS

A plasma display apparatus and a plasma display system in accordance with exemplary embodiments of the present invention will be described hereinafter with reference to the accompanying drawings.

### First Exemplary Embodiment

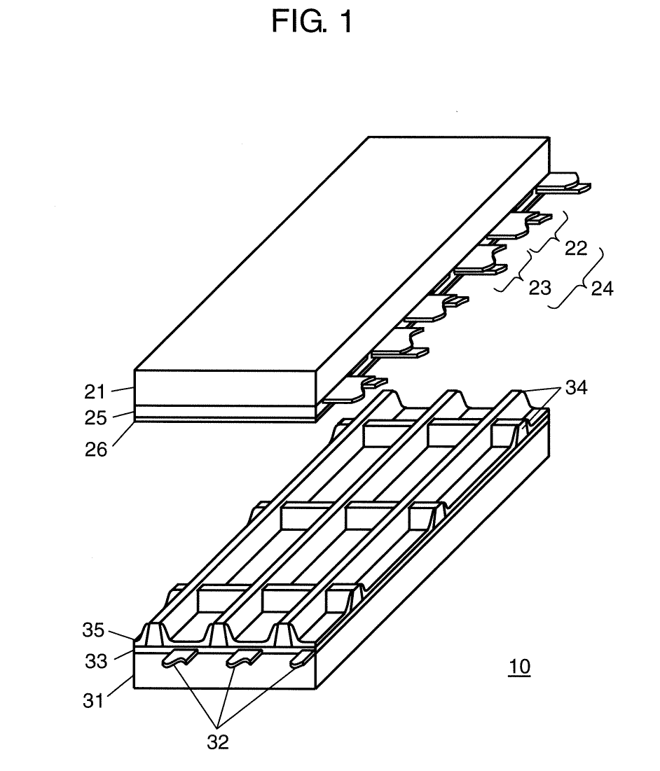

FIG. 1 is an exploded perspective view showing the structure of panel 10 used in a plasma display apparatus in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25.

Protective layer 26 is made of a material mainly made of magnesium oxide (MgO) in order to reduce the discharge start voltage in a discharge cell. The magnesium oxide has been used as a material of a panel, and has a large secondary electron emission coefficient and high durability when neon (Ne) gas and xenon (Xe) gas are filled.

A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting lights of respective colors of red (R), green (G), and blue (B) are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example.

The discharge space is partitioned into a plurality of sections by barrier ribs 34. Discharge cells are formed in the intersecting parts of display electrode pairs 24 and data electrodes 32.

Then, discharge is caused in the discharge cells, and light is emitted (lighting in the discharge cells) in phosphor layers 35 of them, thereby displaying a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B).

The structure of panel 10 is not limited to the above-mentioned one, but may be a structure having striped barrier ribs, for example.

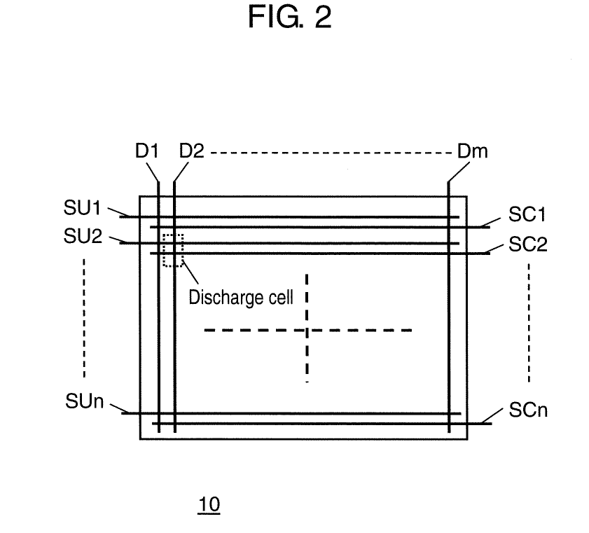

FIG. 2 is an electrode array diagram of panel 10 used in the plasma display apparatus in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended horizontally (row direction), and m data electrode D1 through data electrode Dm (data electrodes 32 in FIG. 1) extended vertically (column direction). A discharge cell is formed in the part where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3 and n is 1080.

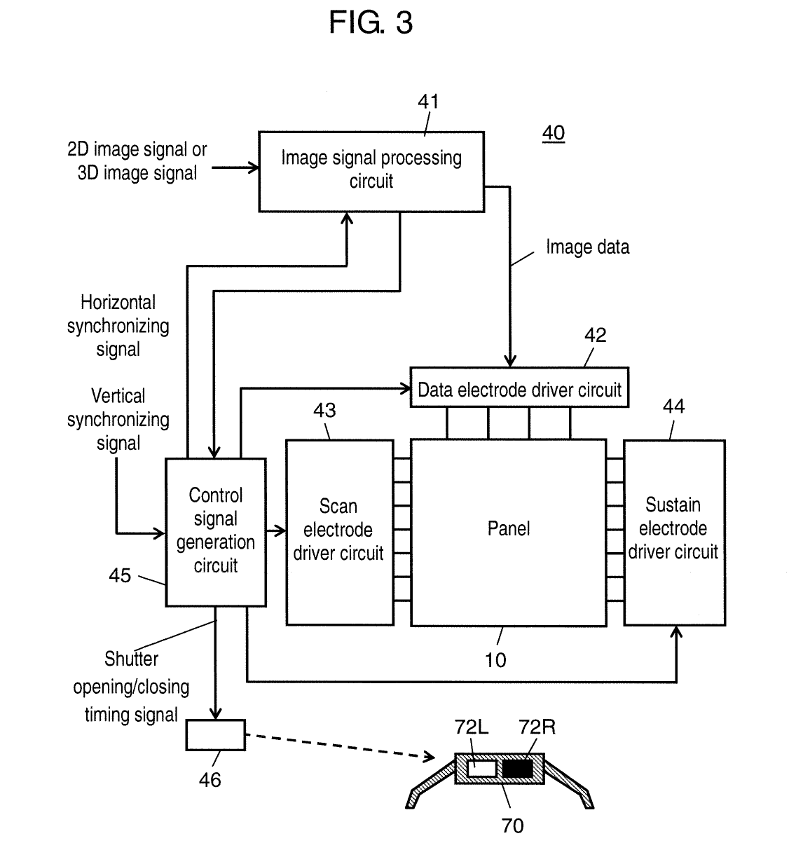

FIG. 3 is a diagram for schematically showing circuit blocks of plasma display apparatus 40 and a plasma display system in accordance with the first exemplary embodiment of the present invention. The plasma display system of the first exemplary embodiment includes, as components, plasma display apparatus 40 and shutter glasses 70.

Plasma display apparatus 40 includes panel 10 having a plurality of discharge cells each of which includes scan electrode 22, sustain electrode 23, and data electrode 32, and a driver circuit for driving panel 10. The driver circuit has the following elements:
image signal processing circuit 41;
data electrode driver circuit 42;
scan electrode driver circuit 43;
sustain electrode driver circuit 44;
control signal generation circuit 45; and
a power supply circuit (not shown) for supplying power required for each circuit block.

The driver circuit drives panel 10 by one of 3D drive for displaying a 3D image on panel 10 and 2D drive for displaying a 2D image on panel 10. The 3D image is displayed by alternately repeating a right-eye field and a left-eye field based on a 3D image signal. The 2D image is displayed based on a 2D image signal having no differentiation between the right-eye and left-eye. Plasma display apparatus 40 also includes timing signal output section 46. Timing signal output section 46 outputs, to shutter glasses 70, a shutter opening/closing timing signal for controlling the opening/closing of the shutters of shutter glasses 70 used by a user. Shutter glasses 70 are used by the user when a 3D image is displayed on panel 10, and the user can 3D-view the 3D image by viewing the 3D image through shutter glasses 70.

Image signal processing circuit 41 receives a 2D image signal or 3D image signal, and assigns a gradation value to each discharge cell based on an input image signal. Then, image signal processing circuit 41 converts the gradation value into image data indicating light emission and no light emission in each subfield (light emission and no light emission are made to correspond to digital signals, “1” and “0”). In other words, image signal processing circuit 41 converts the image signal in each field into image data indicating the light emission and no light emission in each subfield.

For example, when the input image signal includes an R signal, a G signal, and a B signal, image signal processing circuit 41 assigns each gradation value of R, G, and B to each discharge cell based on the R signal, the G signal, and the B signal. When the input image signal includes a luminance signal (Y signal) and a chroma signal (C signal, R-Y signal and B-Y signal, or u signal and v signal), image signal processing circuit 41 calculates the R signal, the G signal, and the B signal based on the luminance signal and chroma signal, and then assigns each gradation value (gradation value represented in one field) of R, G, and B to each discharge cell. Image signal processing circuit 41 converts each gradation value of R, G, and B assigned to each discharge cell into image data that indicates light emission or no light emission in each subfield.

When the input image signal is a 3D image signal for 3D vision having a right-eye image signal and a left-eye image signal, and the 3D image signal is displayed on panel 10, the right-eye image signal and left-eye image signal are alternately input to image signal processing circuit 41 in each field. Therefore, image signal processing circuit 41 converts the right-eye image signal into right-eye image data, and converts the left-eye image signal into left-eye image data.

Control signal generation circuit 45 determines which of a 2D image signal and 3D image signal is input to plasma display apparatus 40 based on an input signal. Based on the determination result, control signal generation circuit 45 generates a control signal for controlling each driver circuit in order to display the 2D image or 3D image.

Specifically, control signal generation circuit 45 determines whether the input signal to plasma display apparatus 40 is a 3D image signal or a 2D image signal based on the frequency of the horizontal synchronizing signal and the vertical synchronizing signal of the input signal. Control signal generation circuit 45 determines that the input signal is a 2D image signal when the horizontal synchronizing signal is 33.75 kHz and the vertical synchronizing signal is 60 Hz, or determines that the input signal is a 3D image signal when the horizontal synchronizing signal is 67.5 kHz and the vertical synchronizing signal is 120 Hz, for example. Based on the horizontal synchronizing signal and the vertical synchronizing signal, control signal generation circuit 45 generates various control signals for controlling the operation of each circuit block. Then, control signal generation circuit 45 supplies the generated control signals to respective circuit blocks (data electrode driver circuit 42, scan electrode driver circuit 43, sustain electrode driver circuit 44, and image signal processing circuit 41).

Control signal generation circuit 45 outputs, to timing signal output section 46, a shutter opening/closing timing signal for controlling the opening/closing of the shutters of shutter glasses 70 when a 3D image is displayed on panel 10. Control signal generation circuit 45 sets the shutter opening/closing timing signal at ON (“1”) when the shutters of shutter glasses 70 are opened (visible light is transmitted), and sets the shutter opening/closing timing signal at OFF (“0”) when the shutters of shutter glasses 70 are closed (visible light is blocked).

The shutter opening/closing timing signal includes the following signals:
a right-eye timing signal (right-eye shutter opening/closing timing signal) that is set at ON when the right-eye field based on the right-eye image signal of the 3D image is displayed on panel 10, and is set at OFF when the left-eye field based on the left-eye image signal is displayed; and
a left-eye timing signal (left-eye shutter opening/closing timing signal) that is set at ON when the left-eye field based on the left-eye image signal of the 3D image is displayed, and is set at OFF when the right-eye field based on the right-eye image signal is displayed.

In the present exemplary embodiment, the fequencies of the horizontal synchronizing signal and vertical synchronizing signal are not limited to the above-mentioned numerical values. When a determination signal for determining the 2D image signal and 3D image signal is added to the input signal, control signal generation circuit 45 may determine which of the 2D image signal and 3D image signal is input based on the determination signal.

Scan electrode driver circuit 43 has an initializing waveform generation circuit, a sustain pulse generation circuit, and a scan pulse generation circuit (not shown in FIG. 3). Scan electrode driver circuit 43 generates a driving voltage waveform based on a control signal supplied from control signal generation circuit 45, and applies it to each of scan electrode SC1 through scan electrode SCn. The initializing waveform generation circuit generates an initializing waveform to be applied to scan electrode SC1 through scan electrode SCn based on the control signal in the initializing period. The sustain pulse generation circuit generates a sustain pulse to be applied to scan electrode SC1 through scan electrode SCn based on the control signal in the sustain period. The scan pulse generation circuit has a plurality of scan electrode driver ICs (scan ICs), and generates a scan pulse to be applied to scan electrode SC1 through scan electrode SCn based on the control signal in the address period.

Sustain electrode driver circuit 44 has a sustain pulse generation circuit and a circuit (not shown in FIG. 3) for generating voltage Ve1 and voltage Ve2. Sustain electrode driver circuit 44 generates a driving voltage waveform based on the control signal supplied from control signal generation circuit 45, and applies it to each of sustain electrode SU1 through sustain electrode SUn. Sustain electrode driver circuit 44 generates a sustain pulse based on the control signal and applies it to sustain electrode SU1 through sustain electrode SUn in the sustain period.

Data electrode driver circuit 42 converts image data based on the 2D image signal or data of each subfield based on the 3D image signal, which constitutes right-eye image data and left-eye image data, into a signal corresponding to each of data electrode D1 through data electrode Dm. Data electrode driver circuit 42 drives each of data electrode D1 through data electrode Dm based on the signal and the control signal supplied from timing generation circuit 45. Data electrode driver circuit 42 generates an address pulse and applies it to each of data electrode D1 through data electrode Dm in the address period.

Timing signal output section 46 has a light emitting element such as a light emitting diode (LED). Timing signal output section 46 converts a shutter opening/closing timing signal into an infrared signal, for example, and supplies it to shutter glasses 70.

Shutter glasses 70 include a signal receiving section (not shown) for receiving a signal (for example, infrared signal) output from timing signal output section 46, right-eye shutter 72R, and left-eye shutter 72L. Right-eye shutter 72R and left-eye shutter 72L can be independently opened or closed. Shutter glasses 70 open or close right-eye shutter 72R and left-eye shutter 72L based on the shutter opening/closing timing signal supplied from timing signal output section 46.

Right-eye shutter 72R is opened (visible light is transmitted) when the right-eye timing signal is in the ON state, and is closed (visible light is blocked) when it is in the OFF state. Left-eye shutter 72L is opened (visible light is transmitted) when the left-eye timing signal is in the ON state, and is closed (visible light is blocked) when it is in the OFF state.

Right-eye shutter 72R and left-eye shutter 72L can be made of liquid crystal, for example. However, the material of the shutters of the present invention is not limited to the liquid crystal, but may be any material as long as the material allows high speed switching between the blocking and transmission of visible light.

Next, a driving voltage waveform and its operation for driving panel 10 are described schematically.

Plasma display apparatus 40 of the present embodiment drives panel 10 by a subfield method. In this subfield method, the plasma display apparatus divides one field into a plurality of subfields on the time axis, and sets luminance weight for each subfield. Therefore, each field has a plurality of subfields. Each subfield has an initializing period, an address period, and a sustain period.

In the initializing period, an initializing operation of causing the initializing discharge in a discharge cell and producing, on each electrode, wall charge required for address discharge in the subsequent address period is performed.

In the address period, the address operation is performed where a scan pulse is applied to scan electrodes 22, an address pulse is selectively applied to data electrodes 32, address discharge is selectively caused in a discharge cell to emit light, and wall charge for generating sustain discharge in the subsequent sustain period is produced in the discharge cell.

In the sustain period, the sustain operation is performed where as many sustain pulses as the number derived by multiplying the luminance weight set for each subfield by a predetermined proportionality coefficient are alternately applied to scan electrode 22 and sustain electrode 23, sustain discharge is caused in the discharge cell having undergone address discharge in the immediately preceding address period, and light is emitted in the discharge cell. This proportionality coefficient is luminance magnification.

The luminance weight means the ratio between the luminances displayed in respective subfields, and as many sustain pulses as the number corresponding to the luminance weight are generated in each subfield in the sustain period. Therefore, in the subfield of luminance weight “8”, light is emitted at a luminance about eight times that in the subfield of luminance weight “1”, and light is emitted at a luminance about four times that in the subfield of luminance weight “2”.

For example, when the luminance magnification is two, four sustain pulses are applied to each of scan electrode 22 and sustain electrode 23 in the sustain period of the subfield of luminance weight “2”. Therefore, the number of sustain pulses occurring in the sustain period is 8.

Therefore, various gradations can be displayed and various images can be displayed on panel 10, by selectively emitting light in each subfield by controlling the light emission or no light emission in each discharge cell in each subfield using a combination corresponding to the image signal.

The initializing operation includes the following operations:
an all-cell initializing operation of causing initializing discharge in a discharge cell regardless of the operation in the immediately preceding subfield; and
a selective initializing operation of selectively causing initializing discharge only in a discharge cell having undergone address discharge in the address period and having undergone sustain discharge in the address period in the immediately preceding subfield.
   In the all-cell initializing operation, an increasing up-ramp waveform voltage and a decreasing down-ramp waveform voltage are applied to scan electrodes 22, and initializing discharge is caused in all discharge cells in the image display region. In the initializing period of one subfield, of a plurality of subfields, an all-cell initializing operation is performed (hereinafter, initializing period for performing the all-cell initializing operation is referred to as “all-cell initializing period”, and a subfield having the all-cell initializing period is referred to as “all-cell initializing subfield”). In the initializing periods of the other subfields, a selective initializing operation is performed (hereinafter, initializing period for performing the selective initializing operation is referred to as “selective initializing period”, and a subfield having the selective initializing period is referred to as “selective initializing subfield”).

In the present exemplary embodiment, the all-cell initializing subfield is only the first subfield of each field (the subfield firstly occurring in the field). In other words, the all-cell initializing operation is performed in the initializing period of the first subfield (subfield SF1), and the selective initializing operation is performed in the initializing periods of the other subfields. Thus, the initializing discharge can be caused in all discharge cells at least once per field, and the address operations after the all-cell initializing operation can be stabilized. The light emission related to no image display is only light emission following the discharge of the all-cell initializing operation in subfield SF1. The luminance of black level, which is luminance in a black displaying region that does not cause sustain discharge, is therefore determined only by weak light emission in the all-cell initializing operation. An image of sharp contrast can be displayed on panel 10.

In the present exemplary embodiment, however, the number of subfields constituting one field and the luminance weight of each subfield are not limited to the above-mentioned numerical values. The subfield structure may be changed based on an image signal or the like.

In the present exemplary embodiment, an image signal to be input to plasma display apparatus 40 is a 2D image signal or 3D image signal, and plasma display apparatus 40 drives panel 10 in response to each image signal. First, a driving voltage waveform applied to each electrode of panel 10 when a 2D image signal is input to plasma display apparatus 40 is described. Next, a driving voltage waveform applied to each electrode of panel 10 when a 3D image signal is input to plasma display apparatus 40 is described.

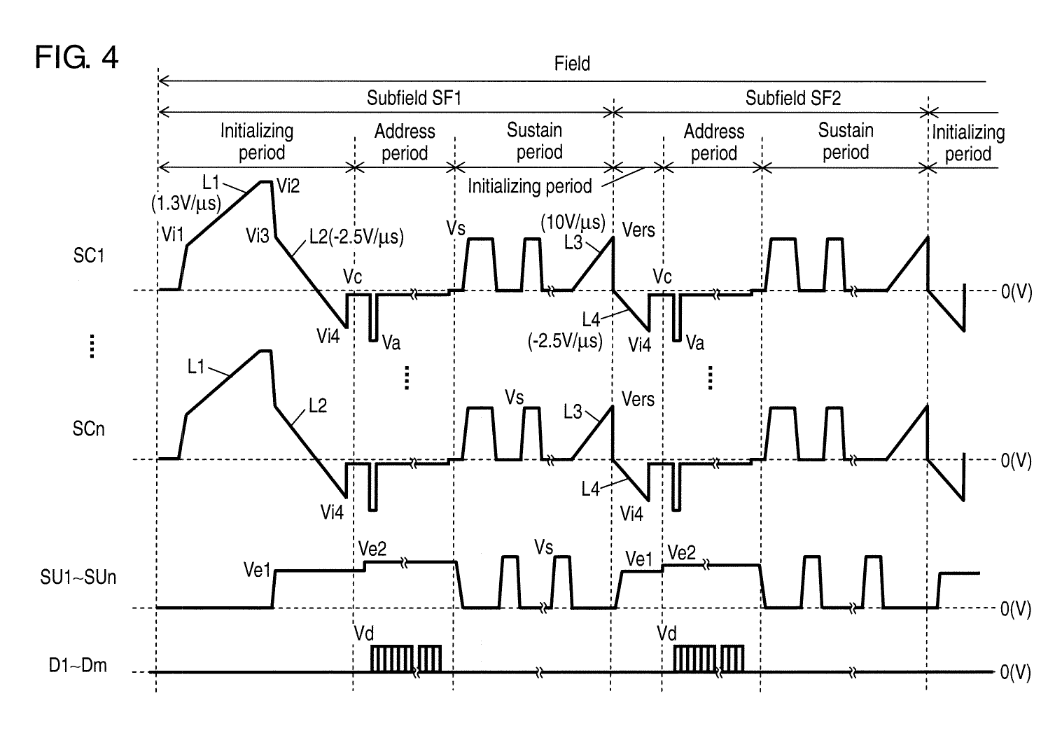

FIG. 4 is a diagram for schematically showing a driving voltage waveform to be applied to each electrode of panel 10 used in the plasma display apparatus in accordance with the first exemplary embodiment of the present invention. FIG. 4 shows driving voltage waveforms applied to scan electrode SC1 for firstly performing an address operation in the address period, scan electrode SCn for finally performing the address operation in the address period, sustain electrode SU1 through sustain electrode SUn, and data electrode D1 through data electrode Dm. Each of scan electrode SCi, sustain electrode SUi, and data electrode Dk discussed later means an electrode that is selected from each kind of electrodes based on image data (which indicates light emission or no light emission in each subfield).

FIG. 4 shows driving voltage waveforms of two subfields, namely subfield SF1 and subfield SF2. The all-cell initializing operation is performed in subfield SF1, and the selective initializing operation is performed in subfield SF2. Therefore, the waveform of the driving voltage to be applied to scan electrode 22 in the initializing period differs between subfield SF1 and subfield SF2. The driving voltage waveforms in the other subfields are the same as the driving voltage waveform in subfield SF2 except for the number of sustain pulses in the sustain period.

In the present exemplary embodiment, when plasma display apparatus 40 drives panel 10 with a 2D image signal, one field is formed of 8 subfields (subfield SF1, subfield SF2, . . . , subfield SF8), and respective subfields, namely subfield SF1 through subfield SF8, have luminance weights of (1, 2, 4, 8, 16, 32, 64, 128).

Thus, when panel 10 is driven with a 2D image signal in the present exemplary embodiment, the luminance weights of respective subfields are set in the following order: the luminance weight of subfield SF1, which is the first subfield in the field, is the smallest, the luminance weights of the subsequent subfields increase sequentially, and the luminance weight of subfield SF8, which is the final subfield in the field, is the largest.

In the present exemplary embodiment, the number of subfields constituting one field and the luminance weight of each subfield are not limited to the above-mentioned values.

First, subfield SF1, which is an all-cell initializing subfield, is described.

First, subfield SF1 is described.

In the first half of the initializing period of subfield SF1 for performing an all-cell initializing operation, voltage 0 (V) is applied to data electrode D1 through data electrode Dm and sustain electrode SU1 through sustain electrode SUn. To scan electrode SC1 through scan electrode SCn, voltage 0 (V) is applied, Vi1 is applied, and then a first up-ramp waveform voltage, which gently (at a gradient of 1.3 V/μsec, for example) increases from voltage Vi1 to voltage Vi2, is applied. Hereinafter, the first up-ramp waveform voltage is referred to as “ramp voltage L1”. Voltage Vi1 is set at the voltage lower than the discharge start voltage with respect to sustain electrode SU1 through sustain electrode SUn. Voltage Vi2 is set at the voltage exceeding the discharge start voltage.

While ramp voltage L1 increases, feeble initializing discharge continuously occurs between scan electrode SC1 through scan electrode SCn and sustain electrode SU1 through sustain electrode SUn in each discharge cell, and feeble initializing discharge continuously occurs between scan electrode SC1 through scan electrode SCn and data electrode D1 through data electrode Dm in each discharge cell. Then, negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrode means voltage generated by the wall charge accumulated on the dielectric layer for covering the electrodes, the protective layer, or the phosphor layers.

In the latter half of the initializing period of subfield SF1, positive voltage Ve1 is applied to sustain electrode SU1 through sustain electrode SUn, and voltage 0 (V) is applied to data electrode D1 through data electrode Dm. First down-ramp waveform voltage, which gently (at a gradient of −2.5 V/μsec, for example) decreases from voltage Vi3 to negative voltage Vi4, is applied to scan electrode SC1 through scan electrode SCn. Hereinafter, the first down-ramp waveform voltage is referred to as “ramp voltage L2”. Voltage Vi3 is set at the voltage lower than the discharge start voltage with respect to sustain electrode SU1 through sustain electrode SUn, and voltage Vi4 is set at the voltage exceeding the discharge start voltage.

While ramp voltage L2 is applied to scan electrode SC1 through scan electrode SCn, feeble initializing discharge occurs between scan electrode SC1 through scan electrode SCn and sustain electrode SU1 through sustain electrode SUn in each discharge cell, and feeble initializing discharge occurs between scan electrode SC1 through scan electrode SCn and data electrode D1 through data electrode Dm in each discharge cell. Then, the negative wall voltage accumulated on scan electrode SC1 through scan electrode SCn and the positive wall voltage accumulated on sustain electrode SU1 through sustain electrode SUn are reduced, and the positive wall voltage accumulated on data electrode D1 through data electrode Dm is adjusted to a value suitable for address operation.

Thus, the initializing operation in the initializing period of subfield SF1, namely the all-cell initializing operation of forcibly causing initializing discharge in all discharge cells, is completed, and the wall charge required for the subsequent address operation is formed on each electrode in all discharge cells.

In the subsequent address period in subfield SF1, voltage Ve2 is applied to sustain electrode SU1 through sustain electrode SUn, and voltage Vc (Va+Vscn) is applied to scan electrode SC1 through scan electrode SCn.

Next, a scan pulse of negative polarity of negative voltage Va is applied to scan electrode SC1 in the first row for firstly performing an address operation. Then, an address pulse of positive polarity of positive voltage Vd is applied to data electrode Dk in the discharge cell to emit light in the first row, of data electrode D1 through data electrode Dm.

The voltage difference in the intersecting part of data electrode Dk and scan electrode SC1 in the discharge cell to which the address pulse of voltage Vd has been applied is derived by adding the difference between the wall voltage on data electrode Dk and that on scan electrode SC1 to the difference (voltage Vd−voltage Va) of the external applied voltage. Thus, the voltage difference between data electrode Dk and scan electrode SC1 exceeds the discharge start voltage, and discharge occurs between data electrode Dk and scan electrode SC1.

Since voltage Ve2 is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (voltage Ve2−voltage Va) of the external applied voltage. At this time, by setting voltage Ve2 at a voltage value slightly lower than the discharge start voltage, a state where discharge does not occur but is apt to occur can be caused between sustain electrode SU1 and scan electrode SC1.

Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell (to emit light) to which a scan pulse and address pulse are simultaneously applied, positive wall voltage is accumulated on scan electrode SC1, negative wall voltage is accumulated on sustain electrode SU1, and negative wall voltage is also accumulated on data electrode Dk.

Thus, the address operation in the discharge cell in the first row is completed. The voltage in the part where scan electrode SC1 intersects with data electrode 32 to which no address pulse has been applied does not exceed the discharge start voltage, so that address discharge does not occur.

Next, a scan pulse is applied to scan electrode SC2 in the second row, an address pulse is applied to data electrode Dk corresponding to the discharge cell to emit light in the second row, and the address operation is performed in the discharge cell of the second row.

This address operation is sequentially performed until it reaches the discharge cell in the n-th row in the order of scan electrode SC3, scan electrode SC4, . . . , and scan electrode SCn, and the address period in subfield SF1 is completed. Thus, in the address period, address discharge is selectively caused in the discharge cell to emit light, and wall charge is formed in the discharge cell.

In the subsequent sustain period in subfield SF1, voltage 0 (V) as base potential is firstly applied to sustain electrode SU1 through sustain electrode SUn, and a sustain pulse of positive voltage Vs is applied to scan electrode SC1 through scan electrode SCn.

In the discharge cell having undergone address discharge, by application of the sustain pulse, the voltage difference between scan electrode SCi and sustain electrode SUi is obtained by adding the difference between the wall voltage on scan electrode SCi and that on sustain electrode SUi to voltage Vs of the sustain pulse.

Thus, the voltage difference between scan electrode SCi and sustain electrode SUi exceeds the discharge start voltage, and sustain discharge occurs between scan electrode SCi and sustain electrode SUi. Ultraviolet rays generated by this discharge cause phosphor layer 35 to emit light. By this discharge, negative wall voltage is accumulated on scan electrode SCi, and positive wall voltage is accumulated on sustain electrode SUi. Positive wall voltage is also accumulated on data electrode Dk. In the discharge cell having undergone no address discharge in the address period, sustain discharge does not occur.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge immediately before it, the voltage difference between sustain electrode SUi and scan electrode SCi exceeds the discharge start voltage. Thus, sustain discharge occurs between sustain electrode SUi and scan electrode SCi again, negative wall voltage is accumulated on sustain electrode SUi, and positive wall voltage is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, by applying the potential difference between the electrodes of display electrode pair 24, sustain discharge is continuously performed in the discharge cell having undergone the address discharge in the address period.

After generation of a sustain pulse in the sustain period (end of the sustain period), in the state where voltage 0 (V) is applied to sustain electrode SU1 through sustain electrode SUn and data electrode D1 through data electrode Dm, ramp waveform voltage, which gently (at a gradient of about 10 V/μsec, for example) increases from voltage 0 (V) as base potential to voltage Vers, is applied to scan electrode SC1 through scan electrode SCn. Hereinafter, the ramp waveform voltage is referred to as “erasing ramp voltage L3”.

While erasing ramp voltage L3 applied to scan electrode SC1 through scan electrode SCn increases beyond the discharge start voltage, feeble discharge continuously occurs in the discharge cell having undergone sustain discharge. Charged particles generated by the feeble discharge are accumulated as wall charge on sustain electrode SUi and scan electrode SCi so as to reduce the voltage difference between sustain electrode SUi and scan electrode SCi. Therefore, the wall voltages on scan electrode SCi and sustain electrode SUi are reduced while the positive wall voltage is left on data electrode Dk. In other words, unnecessary wall charge in the discharge cell is erased.

When the voltage applied to scan electrode SC1 through scan electrode SCn arrives at voltage Vers, the apply voltage to scan electrode SC1 through scan electrode SCn is decreased to voltage 0 (V). Thus, the sustain operation in the sustain period in subfield SF1 is completed.

Thus, subfield SF1 is completed.

In the initializing period of subfield SF2 for performing the selective initializing operation, the driving voltage waveform where the first half of the initializing period of subfield SF1 is omitted is applied to each electrode.

In the initializing period of subfield SF2, voltage Ve1 is applied to sustain electrode SU1 through sustain electrode SUn, and voltage 0 (V) is applied to data electrode D1 through data electrode Dm. Ramp waveform voltage, which decreases from voltage (e.g. voltage 0 (V)) lower than the discharge start voltage to negative voltage Vi4 at the same gradient (e.g. about −2.5 V/μsec) as that of ramp voltage L2, is applied to scan electrode SC1 through scan electrode SCn. Hereinafter, the ramp waveform voltage is referred to as “ramp voltage L4”. Voltage Vi4 is set to exceed the discharge start voltage with respect to sustain electrode SU1 through sustain electrode SUn.

While ramp voltage L4 is applied to scan electrode SC1 through scan electrode SCn, feeble initializing discharge occurs in the discharge cell having undergone the sustain discharge in the sustain period of the immediately preceding subfield (subfield SF1 in FIG. 4). Then, the wall voltages on scan electrode SCi and sustain electrode SUi are reduced by the initializing discharge. Since sufficient positive wall voltage is accumulated on data electrode Dk by sustain discharge occurring in the sustain period of the immediately preceding subfield, the excessive part of this wall voltage is discharged, and the wall voltage on data electrode Dk is adjusted to the wall voltage suitable for the address operation.

In the discharge cell having undergone no sustain discharge in the sustain period of the immediately preceding subfield (subfield SF1), initializing discharge does not occur, and the wall voltage is kept as it is.

The initializing operation in subfield SF2 thus becomes the selective initializing operation of selectively causing initializing discharge in the discharge cell that has undergone address operation in the address period of the immediately preceding subfield, namely in the discharge cell that has undergone sustain discharge in the sustain period of the immediately preceding subfield.

Thus, the initializing operation in the initializing period in subfield SF2, namely the selective initializing operation, is completed.

Ramp voltage L4 has a function similar to that of ramp voltage L2, so that ramp voltage L4 is set as the first down-ramp waveform voltage in the present exemplary embodiment.

In the address period of subfield SF2, the address operation is performed where a driving voltage waveform similar to that in the address period of subfield SF1 is applied to each electrode, and wall voltage is accumulated on each electrode of the discharge cell to emit light.

In the subsequent sustain period, similarly to the sustain period of subfield SF1, as many sustain pulses as the number corresponding to the luminance weight are alternately applied to scan electrode SC1 through scan electrode SCn and sustain electrode SU1 through sustain electrode SUn, and sustain discharge is caused in the discharge cell that has undergone address discharge in the address period.

In the initializing period and address period of each of subfield SF3 and later, a driving voltage waveform similar to that in the initializing period and address period of subfield SF2 is applied to each electrode. In the sustain period of each of subfield SF3 and later, a driving voltage waveform similar to that in subfield SF2 is applied to each electrode except for the number of sustain pulses generated in the sustain period.

The driving voltage waveform applied to each electrode of panel 10 of the present exemplary embodiment has been described schematically.

In the present exemplary embodiment, the following voltage values are applied to respective electrodes, for example. Voltage Vi1 is 145 (V), voltage Vi2 is 335 (V), voltage Vi3 is 190 (V), voltage Vi4 is −160 (V), voltage Va is −180 (V), voltage Vs is 190 (V), voltage Vers is 190 (V), voltage Ve1 is 125 (V), voltage Vet is 130 (V), and voltage Vd is 60 (V). Voltage Vc can be generated by adding positive voltage Vscn=145 (V) to negative voltage Va=−180 (V) (Vc=Va+Vscn), and in this case voltage Vc is −35 (V).

The specific numerical values of the voltage values and gradients of the ramp waveform voltage are simply one example, and the voltage values and gradients of the present invention are not limited to the above-mentioned numerical values. Preferably, the voltage values and gradients are set at optimal values based on the discharge characteristics of the panel and the specification of the plasma display apparatus.

Next, a driving voltage waveform that is applied to each electrode of panel 10 when a 3D image signal is input to plasma display apparatus 40 is described using an opening/closing operation of the shutters of shutter glasses 70.

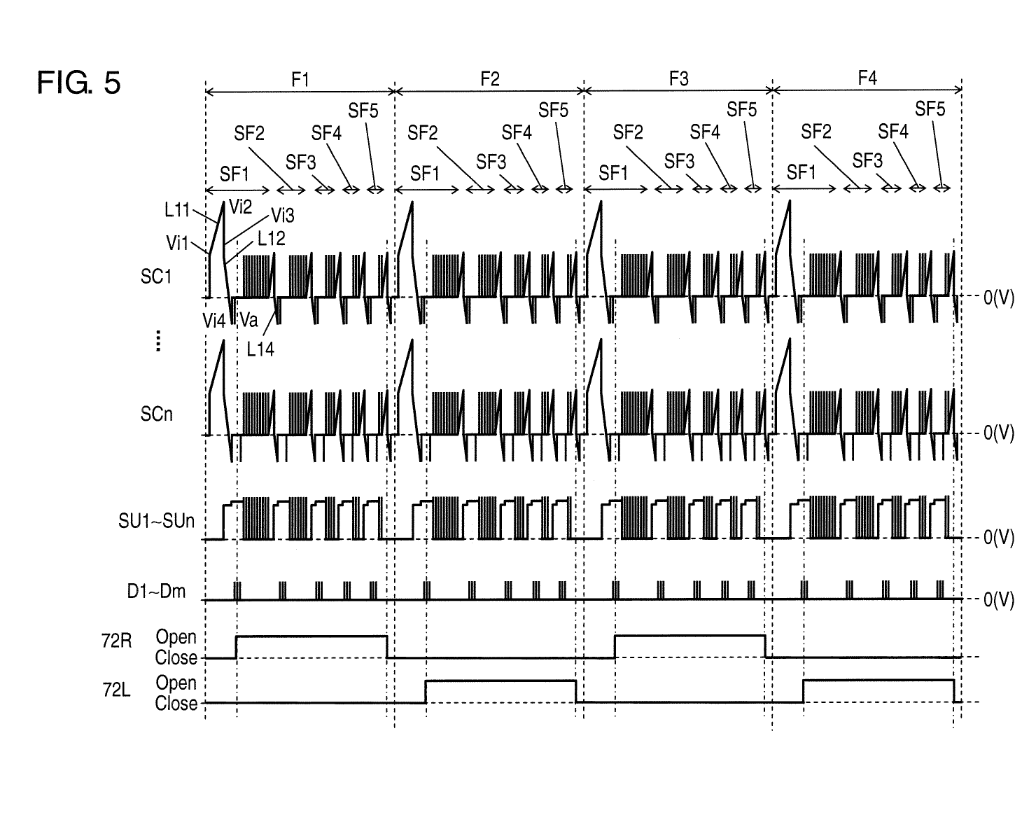

FIG. 5 is a waveform chart for schematically showing a driving voltage waveform applied to each electrode of panel 10 used in plasma display apparatus 40 and an opening/closing operation of shutter glasses 70 in accordance with the first exemplary embodiment of the present invention.

FIG. 5 shows driving voltage waveforms applied to scan electrode SC1 for firstly performing an address operation in the address period, scan electrode SCn for finally performing the address operation in the address period, sustain electrode SU1 through sustain electrode SUn, and data electrode D1 through data electrode Dm. FIG. 5 shows the opening/closing operations of right-eye shutter 72R and left-eye shutter 72L. FIG. 5 shows four fields (field F1 through field F4).

The 3D image signal is an image signal for 3D vision for alternately repeating a right-eye image signal and a left-eye image signal in each field. When the 3D image signal is input, plasma display apparatus 40 alternately displays a right-eye image signal and a left-eye image signal on panel 10 by alternately repeating a right-eye field for displaying a right-eye image signal and a left-eye field for displaying a left-eye image signal. For example, of four fields of FIG. 5, field F1 and field F3 are right-eye fields, and display a right-eye image signal on panel 10. Field F2 and field F4 are left-eye fields, and display a left-eye image signal on panel 10. Plasma display apparatus 40 displays a 3D image for 3D vision formed of a right-eye image and a left-eye image on panel 10.

A user who views a 3D image displayed on panel 10 through shutter glasses 70 recognizes images (right-eye image and left-eye image) displayed in two fields as one 3D image. Therefore, the number of 3D images displayed on panel 10 per unit time (for example, one second) and observed by the user is a half the field frequency (the number of fields generated per second).

For example, when the field frequency (the number of fields generated per second) of the 3D image displayed on the panel is 60 Hz, the number of right-eye images displayed on panel 10 per second is 30 and the number of left-eye images displayed on it per second is 30. The user therefore observes 30 3D images per second. Therefore, in order to display 60 3D images per second, the field frequency must be set at 120 Hz, namely twice 60 Hz. In the present exemplary embodiment, in order that the user can smoothly observe a 3D moving image, the field frequency is set to be twice (for example, 120 Hz) the normal frequency, and fluctuation (flicker) in image apt to occur when an image of low field frequency is displayed is reduced.

The user views a 3D image displayed on panel 10 through shutter glasses 70 for independently opening or closing right-eye shutter 72R and left-eye shutter 72L synchronously with the right-eye field and the left-eye field. Thus, the user can observe the right-eye image only with the right eye and observe the left-eye image only with the left eye, so that the 3D image displayed on panel 10 can be viewed three-dimensionally.

The right-eye field and the left-eye field are different from each other only in the image signal to be displayed. They have the same structure of each field such as the number of subfields constituting one field, luminance weight of each subfield, and arrangement of the subfields. When no differentiation between the right-eye and left-eye is required, the right-eye field and the left-eye field are simply referred to as fields, the right-eye image signal and the left-eye image signal are simply referred to as image signals. The structure of the field may be also called a subfield structure.

As discussed above, in plasma display apparatus 40 of the present exemplary embodiment, the field frequency is set at a frequency (e.g. 120 Hz) that is twice the frequency of the 2D image signal in order to reduce the flicker (display image fluctuates) when panel 10 is driven in response to a 3D image signal. Therefore, the one-field period (e.g. 8.3 msec) when a 3D image signal is displayed on panel 10 is a half the one-field period (e.g. 16.7 msec) when a 2D image signal is displayed on panel 10.

In plasma display apparatus 40 of the present exemplary embodiment, the number of subfields constituting one field is made smaller when panel 10 is driven in response to a 3D image signal than when panel 10 is driven in response to a 2D image signal. In the present exemplary embodiment, an example is described where each of a right-eye field and a left-eye field has five subfields (subfield SF1, subfield SF2, subfield SF3, subfield SF4, subfield SF5). Each subfield has an initializing period, an address period, and a sustain period similarly to the case where panel 10 is driven in response to the 2D image signal. An all-cell initializing operation is performed in the initializing period of subfield SF1, and a selective initializing operation is performed in the initializing periods of the other subfields.

In the present exemplary embodiment, the ramp waveform voltage applied to scan electrode 22 in the all-cell initializing operation has a gradient steeper than that of the ramp waveform voltage when a 2D image is displayed on panel 10. Details of this operation are described later.

Thus, the all-cell initializing period in displaying a 3D image on panel 10 (during 3D drive) is made shorter than that in displaying a 2D image on panel 10 (during 2D drive). When the ramp waveform voltage applied to scan electrode 22 in the all-cell initializing operation is made steep, generally, strong discharge occurs and the luminance of black level increases. In the present embodiment, however, the increase in luminance of black level can be prevented. The reason is described later.

Subfield SF1 through subfield SF5 have luminance weights of (16, 8, 4, 2, 1). Thus, in the present exemplary embodiment, the luminance weights of respective subfields are set so that the luminance weight of subfield SF1, which is the first subfield in the field, is the largest, the luminance weights of the subsequent subfields decrease sequentially, and the luminance weight of subfield SF5, which is the final subfield in the field, is the smallest.

Thus, in the present exemplary embodiment, when a 3D image signal is displayed on panel 10, the luminance weights of the subfields constituting one field sequentially decrease as subfields are sequentially generated, namely the luminance weights of the sequentially generated subfields of one field are decreased. The reason is described below.

Phosphor layer 35 used in panel 10 has afterglow characteristics depending on the material forming the phosphor. The afterglow means the phenomenon where the phosphor continues the light emission even after the completion of discharge. The intensity of the afterglow is proportional to the luminance during the light emission of the phosphors. As the luminance during light emission of the phosphor becomes high, the afterglow becomes strong. There is also a phosphor material having the following characteristics: the afterglow attenuates at a time constant corresponding to the characteristics of the phosphor, and the luminance gradually decreases with the passage of time, but the afterglow continues for several milliseconds even after the completion of sustain discharge. As the luminance during light emission of the phosphor becomes high, the time required for the attenuation becomes long.

The light emission occurring in a subfield of a large luminance weight has a luminance higher than that of the light emission occurring in a subfield of a small luminance weight. Therefore, the luminance of the afterglow by the light emission occurring in a subfield of a large luminance weight is higher than that of the afterglow by the light emission occurring in a subfield of a small luminance weight, and the time required for the attenuation is longer.

Therefore, when the final subfield of one field is set as the subfield of a large luminance weight, the afterglow leaking to the subsequent field is larger than that when the final subfield is set as the subfield of a small luminance weight.

In plasma display apparatus 40 for displaying a 3D image on panel 10 by alternately generating a right-eye field and a left-eye field, when the afterglow occurring in one field leaks into the subsequent field, a user observes the afterglow as unnecessary light emission related to no image signal. This phenomenon is referred to as “crosstalk” in the present embodiment.

Therefore, as the afterglow leaking from one field to the next field increases, the crosstalk degrades, 3D vision of the 3D image is disturbed, and the image display quality in plasma display apparatus 40 reduces. This image display quality means the image display quality for a user who views the 3D image through shutter glasses 70.

In order to reduce the afterglow leaking from one field to the next field and reduce the crosstalk, preferably, a subfield of a large luminance weight is generated in an early time of the one field, strong afterglow is converged in the one field as much as possible, and the final subfield of the one field is made to have the smallest luminance weight to minimize the afterglow leaking to the next field.

In other words, in order to suppress the crosstalk when a 3D image signal is displayed on panel 10, the subfield having the largest luminance weight is generated firstly in the field, the luminance weights of the subsequent subfields are sequentially decreased, and the subfield having the smallest luminance weight is generated at the end of the field. Thus, preferably, the leak of the afterglow to the next field is minimized.

This is the reason why the luminance weights of the subfields constituting one field are set so that those of the subfields generated sequentially are decreased. In the present exemplary embodiment, the number of subfields constituting one field and luminance weights of the subfields are not limited to the above-mentioned numerical values. For example, the structure may be employed where subfield SF1 has the smallest luminance weight, subfield SF2 has the largest luminance weight, subfield SF3 and later have luminance weights that are sequentially decreased, and the final subfield of the field has the second smallest luminance weight.

In the present exemplary embodiment, subfield SF1 is set as the all-cell initializing subfield. Therefore, in the initializing period of subfield SF1, initializing discharge occurs and wall charge and priming particles required for the address operation can be generated in all discharge cells.

However, the wall charge and priming particles generated by the all-cell initializing operation in the initializing period of subfield SF1 gradually disappear with the passage of time. When the wall charge and priming particles become insufficient, the address operation becomes unstable.

The wall charge and priming particles gradually can disappear with the passage of time, and the address operation in the final subfield can become unstable, for example in the discharge cell where the initializing discharge occurs in the all-cell initializing operation of subfield SF1, then no address operation is performed in a midway subfield, and an address operation is performed only in the final subfield.

Therefore, during 2D drive whose one-field period is longer than that during 3D drive, the address operation is apt to become unstable in the discharge cell where an address operation is performed only in the final subfield of one field.

However, the wall charge and priming particles are supplied by the generation of sustain discharge. For example, in the discharge cell where sustain discharge occurs in the sustain period of subfield SF1, the wall charge and priming particles are supplied by the sustain discharge.

In a generally viewed moving image, it is recognized that the occurrence frequency of sustain discharge is higher in a subfield of a relatively small luminance weight than in a subfield of a relatively large luminance weight.

Therefore, during 2D drive whose one-field period is longer than that during 3D drive, a subfield of high sustain discharge occurrence frequency and small luminance weight is generated at the beginning of one field, the luminance weights are increased as subfields are sequentially generated in the one field. Thus, during 2D drive, the occurrence frequency of sustain discharge at the beginning of one field is increased, the number of discharge cells where wall charge and priming particles are supplied is increased by the sustain discharge at the beginning of one field, and the address operation in the final subfield of the one field is stabilized.

During 3D drive, the one-field period is shorter than that during 2D drive. Therefore, the period since the all-cell initializing operation until the address operation in the final subfield is shorter than that during 2D drive. In the discharge cell where an address operation is performed only in the final subfield of one field, the address operation can be performed relatively more stably during 3D drive than during 2D drive. Therefore, a subfield of low sustain discharge occurrence frequency and large luminance weight can be generated at the beginning of one field.

Next, the initializing waveform occurring in the all-cell initializing period is described. In the present exemplary embodiment, the period required for the all-cell initializing operation when a 3D image is displayed on panel 10 is made shorter than that when a 2D image is displayed on panel 10. For this purpose, the gradient of the ramp waveform voltage applied to scan electrode 22 in the all-cell initializing operation is made steeper when the 3D image is displayed on panel 10 than when the 2D image is displayed on panel 10.

In the first half of the initializing period (all-cell initializing period) of subfield SF1 as the all-cell initializing subfield, voltage 0 (V) is applied to data electrode D1 through data electrode Dm and sustain electrode SU1 through sustain electrode SUn. To scan electrode SC1 through scan electrode SCn, voltage 0 (V) is applied, voltage Vi1 is applied, and then a second up-ramp waveform voltage, which increases from voltage Vi1 to voltage Vi2, is applied. Hereinafter, the second up-ramp waveform voltage is referred to as “ramp voltage L11”. Voltage Vi1 is set at the voltage lower than the discharge start voltage with respect to sustain electrode SU1 through sustain electrode SUn. Voltage Vi2 is set at the voltage exceeding the discharge start voltage. In the present exemplary embodiment, the gradient of ramp voltage L11 is made steeper than that of ramp voltage L1 (of the all-cell initializing period shown in FIG. 4).

In the latter half of the initializing period (all-cell initializing period) of subfield SF1, positive voltage Ve1 is applied to sustain electrode SU1 through sustain electrode SUn, and voltage 0 (V) is applied to data electrode D1 through data electrode Dm. Second down-ramp waveform voltage, which decreases from voltage Vi3 to negative voltage Vi4, is applied to scan electrode SC1 through scan electrode SCn. Hereinafter, the second down-ramp waveform voltage is referred to as “ramp voltage L12”. Voltage Vi3 is set at the voltage lower than the discharge start voltage with respect to sustain electrode SU1 through sustain electrode SUn, and voltage Vi4 is set at a voltage exceeding the discharge start voltage. In the present exemplary embodiment, the gradient of ramp voltage L12 is made steeper than that of ramp voltage L2 (of the all-cell initializing period shown in FIG. 4).

In the present exemplary embodiment, the gradient of ramp voltage L11 is made to be twice ramp voltage L1, and the gradient of ramp voltage L12 is made to be twice ramp voltage L2. For example, when the gradient of ramp voltage L1 is 1.3 V/μsec, the gradient of ramp voltage L11 is set at 2.6 V/μsec. When the gradient of ramp voltage L2 is −2.5 V/μsec, the gradient of ramp voltage L12 is set at −5.0 V/μsec.

Thus, the length of the all-cell initializing period when panel 10 is driven based on a 3D image signal can be made shorter than that when panel 10 is driven based on a 2D image signal.

When the gradient of the ramp waveform voltage in the all-cell initializing operation is made steep, stronger light emission occurs in the all-cell initializing operation during 3D drive than in the all-cell initializing operation during 2D drive. In the present exemplary embodiment, however, by controlling shutter glasses 70 as discussed below, this light emission is blocked by right-eye shutter 72R and left-eye shutter 72L and is prevented from entering the eyes of a user.

Next, the control of shutter glasses 70 is described. The opening/closing operation of right-eye shutter 72R and left-eye shutter 72L of shutter glasses 70 is controlled based on ON or OFF of a shutter opening/closing timing signal that is output from timing signal output section 46 and is received by shutter glasses 70.

Control signal generation circuit 45, when the driver circuit of plasma display apparatus 40 performs 3D drive, generates a shutter opening/closing timing signal so that both the right-eye shutter opening/closing timing signal and left-eye shutter opening/closing timing signal are OFF in the all-cell initializing period of the right-eye field and the all-cell initializing period of the left-eye field.

In other words, in the right-eye field (field F1 and field F3 in the example of FIG. 5), a shutter opening/closing timing signal (right-eye shutter opening/closing timing signal) is generated so that right-eye shutter 72R is opened before the start of the sustain period of subfield SF1 as the first subfield and right-eye shutter 72R is closed after the completion of the generation of all sustain pulses in the sustain period of subfield SF5 as the final subfield. In the left-eye field (field F2 and field F4 in the example of FIG. 5), a shutter opening/closing timing signal (left-eye shutter opening/closing timing signal) is generated so that left-eye shutter 72L is opened before the start of the sustain period of subfield SF1 and left-eye shutter 72L is closed after the completion of the generation of sustain pulses in the sustain period of subfield SF5. Hereinafter, a similar operation is repeated in each field.

Therefore, in the present exemplary embodiment, both right-eye shutter 72R and left-eye shutter 72L of shutter glasses 70 are closed in the initializing period (all-cell initializing period) of the all-cell initializing subfield (subfield SF1) in both of the right-eye field and left-eye field. Thus, the light emission generated by the all-cell initializing operation is blocked by right-eye shutter 72R and left-eye shutter 72L, and is prevented from entering the eyes of a user. Thus, a user who views the 3D image through shutter glasses 70 does not observe the light emission generated by the all-cell initializing operation and the luminance corresponding to the light emission is eliminated from the luminance of black level.

The switching timing from ON to OFF of a shutter opening/closing timing signal and the switching timing from OFF to ON thereof are preset in response to the characteristics of shutter glasses 70 and the field structure. Control signal generation circuit 45 generates a shutter opening/closing timing signal in response to the preset timing.

Thus, in the present exemplary embodiment, a user can view a 3D image where the luminance of black level is reduced and the contrast is sharp while the time required for the all-cell initializing period in displaying the 3D image on panel 10 is made shorter than that in displaying a 2D image on panel 10.

The driving voltage waveform applied to each electrode in the selective initializing subfield in subfield SF2 or later is similar to that when a 2D image signal is displayed on panel 10 except that the number of the sustain pulses generated in the sustain period differs and the gradient of ramp voltage L14 applied to scan electrode 22 in the initializing period is made steeper than that of ramp voltage L4. Here, the gradient of ramp voltage L14 is the same as that of ramp voltage L12, for example −5.0 V/μsec. Therefore, the description of this driving voltage waveform is omitted.

In the present exemplary embodiment, the “shutter closed” state is not limited to the state where right-eye shutter 72R and left-eye shutter 72L are completely closed. The “shutter opened” state is not limited to the state where right-eye shutter 72R and left-eye shutter 72L are completely opened.

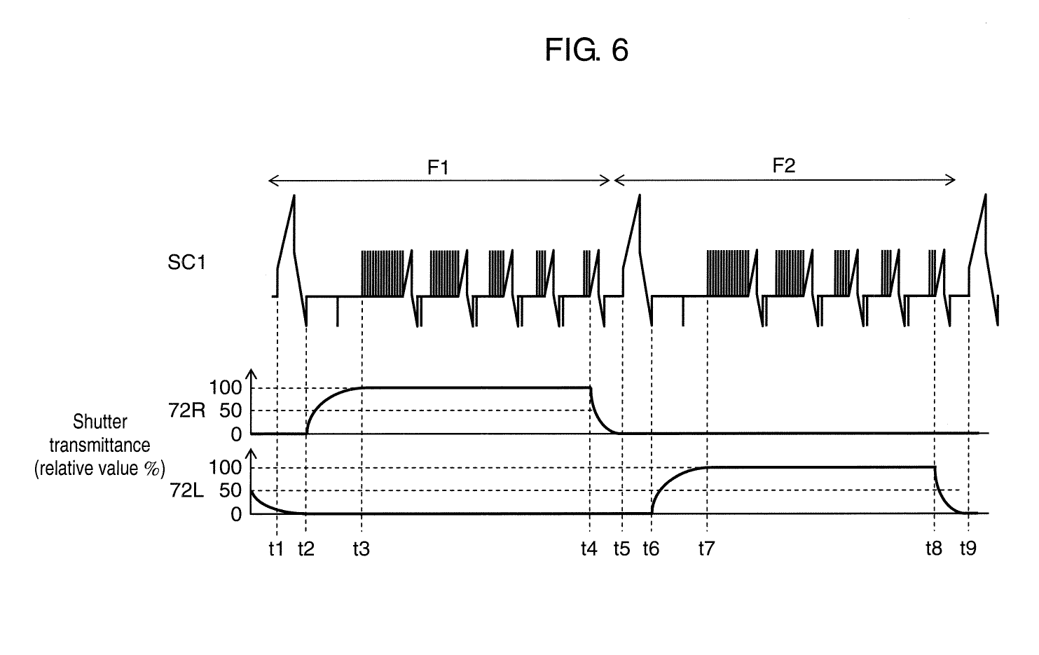

FIG. 6 is a diagram for schematically showing a subfield structure and an opened/closed state of right-eye shutter 72R and left-eye shutter 72L when a 3D image is displayed on plasma display apparatus 40 in accordance with the first exemplary embodiment of the present invention. FIG. 6 shows a driving voltage waveform applied to scan electrode SC1, and the opened/closed state of right-eye shutter 72R and left-eye shutter 72L of shutter glasses 70. FIG. 6 shows two fields (right-eye field F1 and left-eye field F3).

The diagram showing the opened/closed state of shutter glasses 70 of FIG. 6 shows the opened/closed state of right-eye shutter 72R and left-eye shutter 72L using the transmittance. The transmittance means the rate (percentage) of transmitting visible light, assuming that the completely opened state of a shutter has transmittance of 100% (maximum transmittance) and the completely closed state of a shutter has transmittance of 0% (minimum transmittance). In the diagram showing the opening or closing of the shutter of FIG. 6, the vertical axis relatively shows transmittance of the shutter, and the horizontal axis shows time.

In the present exemplary embodiment, when a shutter of shutter glasses 70 is closed, at time t1 immediately before the start of the all-cell initializing operation of field F1, the timing of closing the shutter is preferably set so that left-eye shutter 72L having been opened until then is closed completely and both left-eye shutter 72L and right-eye shutter 72R have transmittance of 0%. At time t5 immediately before the start of the all-cell initializing operation of field F2, the timing of closing the shutter is preferably set so that right-eye shutter 72R having been opened until then is closed completely and both left-eye shutter 72L and right-eye shutter 72R have transmittance of 0%.

When a shutter of shutter glasses 70 is opened, at time t3 immediately before the start of the sustain period of the first subfield (subfield SF1) of field F1, the timing of opening the shutter is preferably set so that right-eye shutter 72R is opened completely and right-eye shutter 72R has transmittance of 100%. At time t7 immediately before the start of the sustain period of the first subfield (subfield SF1) of field F2, preferably, the timing of opening the shutter is set so that left-eye shutter 72L is opened completely and left-eye shutter 72L has transmittance of 100%.

However, the opening/closing operation of a shutter of the present invention is not limited to this structure.

In shutter glasses 70, the time since each shutter starts to be closed until it is closed completely or the time since each shutter starts to be opened until it is opened completely depends on the characteristics of the material (for example, liquid crystal) of which the shutter is made. For example, when the shutter glasses have shutters made of liquid crystal, the time since each shutter starts to be closed until it is closed completely is about 0.5 msec, and the time since each shutter starts to be opened until it is opened completely is about 2 msec.

In the present exemplary embodiment, when each shutter is closed, the timing of closing the shutter is set so that the transmittance of the shutter is 30% or lower, preferably 10% or lower immediately before the start of the all-cell initializing operation. In the example of FIG. 6, the timing of closing the shutter is set so that the transmittance of left-eye shutter 72L is 30% or lower preferably 10% or lower at time t1 (also time t9) immediately before the start of the all-cell initializing operation of subfield SF1 as the first subfield of right-eye field F1. The timing of closing the shutter is set so that the transmittance of right-eye shutter 72R is 30% or lower, preferably 10% or lower at time t5 immediately before the start of the all-cell initializing operation of subfield SF1 as the first subfield of left-eye field F2.

At this time, preferably, the time since the completion of the generation of a sustain pulse until the start of the all-cell initializing operation of the first subfield is set in the sustain period of the final subfield in consideration of the time since each shutter starts to be closed until it is closed completely. In the example of FIG. 6, at least when right-eye shutter 72R starts to be closed at time t4 immediately after the completion of the generation of the sustain pulse in subfield SF5 as the final subfield of right-eye field F1, the interval between time t4 and time t5 is set so that the transmittance of right-eye shutter 72R at time t5 is 30% or lower, preferably 10% or lower.

Similarly, at least when left-eye shutter 72L starts to be closed at time t8 immediately after the completion of the generation of the sustain pulse in subfield SF5 as the final subfield of left-eye field F2, the interval between time t8 and time t9 is set so that the transmittance of left-eye shutter 72L is 30% or lower, preferably 10% or lower at time t9 immediately before the start of the all-cell initializing operation of subfield SF1 of the subsequent right-eye field.

When each shutter is opened, the timing of opening the shutter is set so that the transmittance of the shutter is 70% or higher, preferably 90% or higher immediately before the start of the sustain period of the first subfield (subfield SF1). In the example of FIG. 6, the timing of opening the shutter is set so that the transmittance of right-eye shutter 72R is 70% or higher, preferably 90% or higher at time t3 immediately before the generation of the sustain pulse in subfield SF1 of right-eye field FL The timing of opening the shutter is set so that the transmittance of left-eye shutter 72L is 70% or higher, preferably 90% or higher at time t7 immediately before the generation of the sustain pulse in subfield SF1 of left-eye field F2.

At this time, preferably, the time since the completion of the all-cell initializing operation until the start of the generation of a sustain pulse is set in consideration of the time since the shutter starts to be opened until it is opened completely. In the example of FIG. 6, at least when right-eye shutter 72R starts to be opened at time t2 immediately after the completion of the all-cell initializing operation in subfield SF1 of right-eye field F1, the interval between time t2 and time t3 is set so that the transmittance of right-eye shutter 72R at time t3 is 70% or higher, preferably 90% or higher.

Similarly, at least when left-eye shutter 72L starts to be opened at time t6 immediately after the completion of the all-cell initializing operation in subfield SF1 of left-eye field F2, the interval between time t6 and time t7 is set so that the transmittance of left-eye shutter 72L is 70% or higher, preferably 90% or higher at time t7.

Thus, in the present exemplary embodiment, the opening/closing operation of each shutter is controlled in consideration of the time since each shutter starts to be closed until it is closed completely and the time since each shutter starts to be opened until it is opened completely.

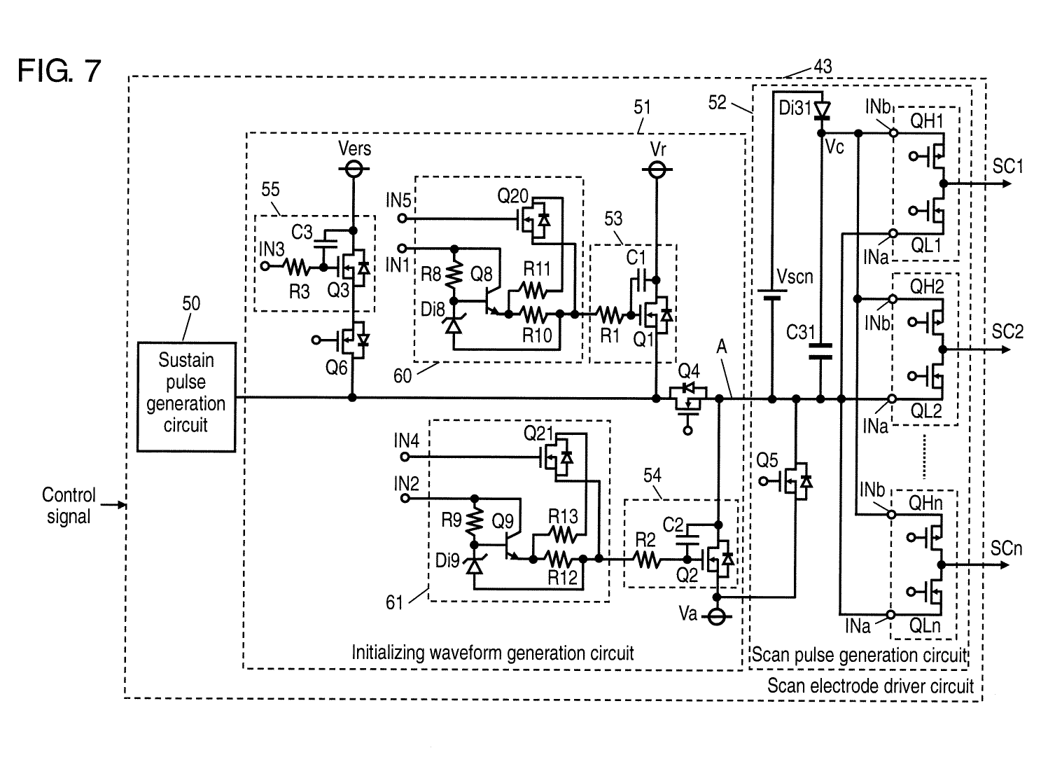

FIG. 7 is a circuit block diagram for schematically showing one configuration example of scan electrode driver circuit 43 of plasma display apparatus 40 in accordance with the first exemplary embodiment of the present invention.

Scan electrode driver circuit 43 has sustain pulse generation circuit 50 on the scan electrode 22 side, initializing waveform generation circuit 51, and scan pulse generation circuit 52. Each output part of scan pulse generation circuit 52 is connected to each of scan electrode SC1 through scan electrode SCn of panel 10. This connection allows that a scan pulse is applied to each scan electrode 22 in an address period.

In the present exemplary embodiment, voltage applied to scan pulse generation circuit 52 is referred to as “reference potential A”. In the following descriptions, an operation of conducting a switching element is denoted with “ON”, the operation of blocking it is denoted with “OFF”, a signal for setting a switching element at ON is denoted with “Hi”, and a signal for setting it at OFF is denoted with “Lo”.

FIG. 7 shows a separation circuit employing switching element Q4 for electrically separating a circuit (e.g. Miller integrating circuit 54) using negative voltage Va from sustain pulse generation circuit 50, a circuit (e.g. Miller integrating circuit 53) using voltage Vr, and a circuit (e.g. Miller integrating circuit 55) using voltage Vers while the circuit using negative voltage Va is operating. FIG. 7 shows a separation circuit employing switching element Q6 for electrically separating the circuit (e.g. Miller integrating circuit 53) using negative voltage Vr from the circuit (e.g. Miller integrating circuit 55) using voltage Vers lower than voltage Vr while the circuit using negative voltage Vr is operating. Each circuit constituting scan electrode driver circuit 43 is controlled based on a control signal generated by control signal generation circuit 45, and scan pulse generation circuit 52 is controlled also based on image data. Details of the signal paths of these control signals are omitted in FIG. 7.

Sustain pulse generation circuit 50 has a generally used power recovery circuit (not shown) and a clamping circuit (not shown), and generates a sustain pulse by switching the switching elements included in it based on a control signal output from control signal generation circuit 45. The clamping circuit can clamp reference potential A on voltage 0 (V) as the base potential, and can clamp reference potential A on voltage Vs.

Scan pulse generation circuit 52 has switching element QH1 through switching element QHn and switching element QL1 through switching element QLn for applying scan pulse voltage to n scan electrode SC1 through scan electrode SCn, respectively. Switching element QH1 through switching element QHn and switching element QL1 through switching element QLn are classified into groups each of which has a plurality of output parts. The groups are integrated as integrated circuits (ICs). These ICs are scan ICs.

Scan pulse generation circuit 52 has switching element Q5 for connecting reference potential A to negative voltage Va in the address period, power supply Vscn for generating voltage Vc in which voltage Vscn is added to reference potential A, diode Di31, and capacitor C31. Voltage Vc is connected to input terminal INb of each of switching element QH1 through switching element QHn, and reference potential A is connected to input terminal INa of each of switching element QL1 through switching element QLn.

Scan pulse generation circuit 52 having such a configuration, in the address period, sets switching element Q5 at ON to make reference potential A equal to negative voltage Va, applies negative voltage Va to input terminals INa, and applies voltage Vc (voltage Va+voltage Vscn, at this time) to input terminals INb. Based on the image data, negative scan pulse voltage Va is applied to scan electrode SCi, to which a scan pulse is to be applied, via switching element QLi by setting switching element QHi at OFF and switching element QLi at ON. Voltage Va+voltage Vscn is applied to scan electrode SCh (h is 1 through n except to which no scan pulse is to be applied, via switching element QHh by setting switching element QLh at OFF and switching element QHh at ON.

Scan pulse generation circuit 52 is controlled by control signal generation circuit 45 so as to output the voltage waveform generated by initializing waveform generation circuit 51 in the initializing period and output the voltage waveform generated by sustain pulse generation circuit 50 in the sustain period.

Initializing waveform generation circuit 51 has Miller integrating circuit 53, Miller integrating circuit 54, Miller integrating circuit 55, constant current generation circuit 60, and constant current generation circuit 61. Miller integrating circuit 53 and Miller integrating circuit 55 are ramp waveform voltage generation circuits for generating an increasing ramp waveform voltage, and Miller integrating circuit 54 is a ramp waveform voltage generation circuit for generating a decreasing ramp waveform voltage. In FIG. 7, the input terminal of constant current generation circuit 60 is expressed by input terminal IN1, the input terminal of Miller integrating circuit 55 is expressed by input terminal IN3, and the input terminal of constant current generation circuit 61 is expressed by input terminal IN2.

Miller integrating circuit 55 has switching element Q3, capacitor C3, and resistor R3, and generates erasing up-ramp voltage L3 by increasing reference potential A to voltage Vers at a gradient (e.g. 10 V/μsec) steeper than that of ramp voltage L1 at the end of the sustain period.

Miller integrating circuit 53 has switching element Q1, capacitor C1, and resistor R1. During the all-cell initializing operation for displaying a 2D image, Miller integrating circuit 53 generates ramp voltage L1 by gently increasing reference potential A to voltage Vi2 in a ramp shape (at a gradient of 1.3 V/μsec, for example). During the all-cell initializing operation for displaying a 3D image, Miller integrating circuit 53 generates ramp voltage L11 by increasing reference potential A to voltage Vi2 at a gradient (e.g. 2.6 V/μsec) steeper than that of ramp voltage L1.

Constant current generation circuit 60 has transistor Q8 whose collector is connected to input terminal IN1, resistor R8 inserted between input terminal IN1 and the base of transistor Q8, Zener diode Dib whose cathode is connected to resistor R8 and anode is connected to resistor R1, and resistor R10 connected between the emitter of transistor Q8 and resistor R1 in series. By applying a predetermined voltage (e.g. 5 (V)) to input terminal IN1, constant current is generated. This constant current is input into Miller integrating circuit 53, and Miller integrating circuit 53 increases the potential value of reference potential A during the input of the constant current.

Constant current generation circuit 60 has switching element Q20 whose gate is input terminal INS. Switching element Q20 is set at ON when the control signal applied to input terminal IN5 is “Hi” (e.g. 5 (V)), or set at OFF when the control signal is “Lo” (e.g. 0 (V)). Constant current generation circuit 60 has resistor R11 for changing the current value of the constant current output from constant current generation circuit 60 by switching operation of switching element Q20.

Specifically, one terminal of resistor R11 is connected to the node between resistor R10 and transistor Q8, and the other terminal is connected to the drain of switching element Q20. The source of switching element Q20 is connected to the node between resistor R11 and resistor R1. Thus, by setting switching element Q20 at ON, resistor R10 and resistor R11 are electrically interconnected in parallel. The current value of the constant current output from constant current generation circuit 60 therefore becomes larger than that when switching element Q20 is at OFF. Thus, the gradient of the ramp waveform voltage output from Miller integrating circuit 53 can be increased.

Thus, Miller integrating circuit 53 can generate two ramp waveform voltages of different gradients, namely ramp voltage L1 used for displaying a 2D image on panel 10 and ramp voltage L11 used for displaying a 3D image on panel 10. In other words, when a 2D image is displayed on panel 10, Miller integrating circuit 53 puts the control signal that is output from control signal generation circuit 45 and applied to input terminal IN5 into the “Lo” state, and generates ramp voltage L1. When a 3D image is displayed on panel 10, Miller integrating circuit 53 puts the control signal that is applied to input terminal INS into the “Hi” state, and generates ramp voltage L11 of a gradient steeper than that of ramp voltage L1.

Miller integrating circuit 54 has switching element Q2, capacitor C2, and resistor R2. During the initializing operation for displaying a 2D image, Miller integrating circuit 54 generates ramp voltage L2 (or ramp voltage L4) by gently decreasing reference potential A to voltage Vi4 in a ramp shape (at a gradient of −2.5 V/μsec, for example). During the initializing operation for displaying a 3D image, Miller integrating circuit 54 generates ramp voltage L12 (or ramp voltage L14) by decreasing reference potential A to voltage Vi4 at a gradient (e.g. −5.0 V/μsec) steeper than that of ramp voltage L2.

Constant current generation circuit 61 has transistor Q9 whose collector is connected to input terminal IN2, resistor R9 inserted between input terminal IN2 and the base of transistor Q9, Zener diode Dig whose cathode is connected to resistor R9 and anode is connected to resistor R2, and resistor R12 connected between the emitter of transistor Q9 and resistor R2 in series. By applying a predetermined voltage (e.g. 5 (V)) to input terminal IN2, constant current is generated. This constant current is input into Miller integrating circuit 54, and Miller integrating circuit 54 decreases the potential value of reference potential A during the input of the constant current.

Constant current generation circuit 61 has switching element Q21 whose gate is input terminal IN4. Switching element Q21 is set at ON when the control signal applied to input terminal IN4 is “Hi” (e.g. 5 (V)), or set at OFF when the control signal is “Lo” (e.g. 0 (V)). Constant current generation circuit 61 has resistor R13 for changing the current value of the constant current output from constant current generation circuit 61 by switching operation of switching element Q21.

Specifically, one terminal of resistor R13 is connected to the node between resistor R12 and transistor Q9, and the other terminal is connected to the drain of switching element Q21. The source of switching element Q21 is connected to the node between resistor R12 and resistor R2. Thus, by setting switching element Q21 at ON, resistor R12 and resistor R13 are electrically interconnected in parallel. The current value of the constant current output from constant current generation circuit 61 therefore becomes larger than that when switching element Q21 is at OFF. Thus, the gradient of the ramp waveform voltage output from Miller integrating circuit 54 can be increased.

Thus, Miller integrating circuit 54 can generate two ramp waveform voltages of different gradients, namely ramp voltage L2 used for displaying a 2D image on panel 10 and ramp voltage L12 used for displaying a 3D image on panel 10. In other words, when a 2D image is displayed on panel 10, Miller integrating circuit 54 puts the control signal that is output from control signal generation circuit 45 and applied to input terminal IN4 into the “Lo” state, and generates ramp voltage L2. When a 3D image is displayed on panel 10, Miller integrating circuit 54 puts the control signal that is applied to input terminal IN5 into the “Hi” state, and generates ramp voltage L12 of a gradient steeper than that of ramp voltage L2.

The control signal for controlling each circuit is supplied from control signal generation circuit 45.

Thus, in the present exemplary embodiment, the gradient of the ramp waveform voltage generated during the all-cell initializing operation in driving the panel 10 based on a 3D image signal is steeper than that during the all-cell initializing operation in driving the panel 10 based on a 2D image signal. Thus, the time required for the all-cell initializing operation in driving panel 10 based on the 3D image signal can be made shorter than that for the all-cell initializing operation in driving the panel 10 based on the 2D image signal. Shutter glasses 70 are controlled so that both right-eye shutter 72R and left-eye shutter 72L are closed in the all-cell initializing period of the right-eye field and in the all-cell initializing period of the left-eye field. Thus, a user who views a 3D image displayed on panel 10 through shutter glasses 70 does not observe the light emission generated by the all-cell initializing operation, and can view a 3D image having sharp contrast obtained by generating an excellent luminance of black level where the luminance corresponding to the light emission by the all-cell initializing operation is eliminated.

In the present exemplary embodiment, the configuration where the gradient of ramp voltage L11 is set to be twice that of ramp voltage L1 has been described. However, the upper limit of the gradient of ramp voltage L11 is preferably set at 4.0 V/μsec. In other words, preferably, the gradient of ramp voltage L11 is set in the range that is larger than the gradient of ramp voltage L1 and is not larger than 4.0 V/μsec. This is because there is a possibility that, when the gradient is steeper than this upper limit, strong discharge occurs during the initializing operation, the initializing operation becomes excessive, and the address operation becomes unstable. However, the present invention is not limited to this numerical value. Numerical values are preferably set optimally in response to the characteristics of panel 10 or the specification of plasma display apparatus 40.

In the present exemplary embodiment, the configuration where the gradient of ramp voltage L12 is set to be twice that of ramp voltage L2 has been described. However, the upper limit of the gradient of ramp voltage L12 is preferably set to be twice that of ramp voltage L2 (or set at −5.0 V/μsec). In other words, preferably, the gradient of ramp voltage L12 is set in the range that is larger than the gradient of ramp voltage L2 and is not larger than twice the gradient of ramp voltage L2. This is because down-ramp waveform voltage in the all-cell initializing operation adjusts the wall charge and priming particles in a discharge cell, and this adjusting function can become excessive to make the address operation unstable when the gradient of ramp voltage L12 is steeper than this upper limit. However, the present invention is not limited to this numerical value. Numerical values are preferably set optimally in response to the characteristics of panel 10 or the specification of plasma display apparatus 40.

In the present exemplary embodiment, the configuration where voltage Vi2 during 3D drive and voltage Vi2 during 2D drive are set at the same voltage value has been described. These may have different voltage values.

### Second Exemplary Embodiment

In the first exemplary embodiment, the configuration has been described where the all-cell initializing operation is performed during 3D drive while the gradient of ramp voltage L11 is set to be steeper than that of ramp voltage L1 and the gradient of ramp voltage L12 is set to be steeper than that of ramp voltage L2. However, the present invention is not limited to this configuration.

In the all-cell initializing operation, discharge by up-ramp waveform voltage causes generation of wall charge and priming particles in a discharge cell. Therefore, dependently on the characteristics of panel 10 or the specification of plasma display apparatus 40, there is a possibility that, when the gradient of the up-ramp waveform voltage becomes steep, strong discharge occurs, the wall charge and priming particles occur excessively, and the subsequent address operation becomes unstable. Therefore, in order to appropriately generate the wall charge and priming particles and stabilize the subsequent address operation, the configuration may be employed where the gradient of ramp voltage L11 is set to be equal to that of ramp voltage L1 and only the gradient of ramp voltage L12 is set to be steeper than that of ramp voltage L2.

In such a configuration, when a 3D image is displayed on panel 10, the all-cell initializing operation during 3D drive is performed while the control signal applied to input terminal IN5 is set at “Lo” to make the gradient of ramp voltage L11 equal to that of ramp voltage L1 and the control signal applied to input terminal IN4 is set at “Hi” to make the gradient of ramp voltage L12 steeper than that of ramp voltage L2.

In the all-cell initializing operation, discharge by down-ramp waveform voltage adjusts the wall charge and priming particles generated in a discharge cell by discharge by up-ramp waveform voltage. Therefore, dependently on the characteristics of panel 10 or the specification of plasma display apparatus 40, there is a possibility that, when the gradient of the down-ramp waveform voltage becomes steep, strong discharge occurs, this function of adjusting the wall charge and priming particles becomes excessive, and the subsequent address operation becomes unstable. Therefore, in order to appropriately adjust the wall charge and priming particles and stabilize the subsequent address operation, the configuration may be employed where the gradient of ramp voltage L12 is set to be equal to that of ramp voltage L2 and only the gradient of ramp voltage L11 is set to be steeper than that of ramp voltage L1.

In such a configuration, when a 3D image is displayed on panel 10, the all-cell initializing operation during 3D drive is performed while the control signal applied to input terminal IN4 is set at “Lo” to make the gradient of ramp voltage L12 equal to that of ramp voltage L2 and the control signal applied to input terminal IN5 is set at “Hi” to make the gradient of ramp voltage L11 steeper than that of ramp voltage L1.

In all of the above-mentioned configurations, the length of the all-cell initializing period during 3D drive is longer than that of the configuration shown in the first exemplary embodiment. Therefore, afterglow leaking from the preceding field to the present field is smaller by the value corresponding to the length difference when right-eye shutter 72R (or left-eye shutter 72L) is opened, so that the effect of reducing the crosstalk can be improved.

The driving voltage waveforms shown in FIG. 4, FIG. 5, and FIG. 6 are simply one example in the exemplary embodiments of the present invention, and the present invention is not limited to these driving voltage waveforms. The circuit configuration of FIG. 7 is also simply one example in the exemplary embodiments of the present invention, and the present invention is not limited to this circuit configuration.

FIG. 5 shows the example where a down-ramp waveform voltage is generated and applied to scan electrode SC1 through scan electrode SCn in the period after the completion of subfield SF5 before the start of subfield SF1. These voltages do not need to be generated. For example, the configuration may be employed where all of scan electrode SC1 through scan electrode SCn, sustain electrode SU1 through sustain electrode SUn, and data electrode D1 through data electrode Dm are kept at 0 (V) in the period after the completion of subfield SF5 before the start of subfield SF1.

In the exemplary embodiments of the present invention, one field is constituted by eight subfields during 2D drive and one field is constituted by five subfields during 3D drive. However, the number of subfields constituting one field is not limited to these numbers. For example, by increasing the number of subfields, the number of gradations capable of being displayed on panel 10 can be increased.

In the exemplary embodiments of the present invention, the luminance weights of the subfields are set at powers of “2”. For example, the luminance weights of subfield SF1 through subfield SF8 are set at (1, 2, 4, 8, 16, 32, 64, 128) during 2D drive, and the luminance weights of subfield SF1 through subfield SF5 are set at (16, 8, 4, 2, 1) during 3D drive. However, the luminance weights of the subfields are not limited to these numerical values. When the combination of the subfields for determining the gradation is made flexible, for example, the luminance weights of subfield SF1 through subfield SF5 are set at (12, 7, 3, 2, 1) or the like during 3D drive, the coding for suppressing occurrence of the moving image false contour is allowed. The number of subfields constituting one field and the luminance weights of the subfields are set appropriately in response to the characteristics of panel 10 and the specification of plasma display apparatus 40.

Each circuit block shown in the exemplary embodiments of the present invention may be configured as an electric circuit for performing each operation shown in the exemplary embodiments, or may be configured using a microcomputer or the like programmed so as to perform a similar operation.

In the present embodiments, an example where one pixel is formed of discharge cells of three colors R, G, and B has been described. However, also in a panel where one pixel is formed of discharge cells of four or more colors, the configuration shown in the present embodiment can be applied and a similar effect can be produced.

Each specific numerical value shown in the exemplary embodiments of the present invention is set based on the characteristics of panel 10 having a screen size of 50 inches and having 1024 display electrode pairs 24, and is simply one example in the embodiments. The present invention is not limited to these numerical values. Numerical values are preferably set optimally in response to the characteristics of the panel or the specification of the plasma display apparatus. These numerical values can vary in a range allowing the above-mentioned effect. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

In a plasma display apparatus usable as a 3D image display apparatus of the present invention, a 3D image of sharp contrast can be achieved while the time required for driving the panel in displaying the 3D image is reduced. Therefore, the present invention is useful as a plasma display apparatus, a plasma display system, a driving method of a panel, and a control method of shutter glasses for the plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35 phosphor layer
40 plasma display apparatus
41 image signal processing circuit
42 data electrode driver circuit
43 scan electrode driver circuit
44 sustain electrode driver circuit
45 control signal generation circuit
46 timing signal output section
50 sustain pulse generation circuit
51 initializing waveform generation circuit
52 scan pulse generation circuit
53, 54, 55 Miller integrating circuit
60, 61 constant current generation circuit
70 shutter glasses
72R right-eye shutter
72L left-eye shutter
Q1, Q2, Q3, Q4, Q5, Q6, Q20, Q21, QH1 through QHn, QL1 through QLn switching element
C1, C2, C3, C31 capacitor
Di31 diode
Di8, Di9 Zener diode
R1, R2, R3, R8, R9, R10, R11, R12, R13 resistor
Q8, Q9 transistor
L1, L2, L4, L11, L12, L14 ramp voltage
L3 erasing ramp voltage

1. A plasma display apparatus comprising:
a plasma display panel having a plurality of discharge cells each of which includes a display electrode pair formed of a scan electrode and a sustain electrode;
a driver circuit, wherein
the driver circuit forms one field using a plurality of subfields each of which has an initializing period, an address period, and a sustain period,
the driver circuit sets, as a first subfield of one field, an all-cell initializing subfield having an all-cell initializing period in which an increasing up-ramp waveform voltage and a decreasing down-ramp waveform voltage are applied to the scan electrode in the initializing period, and
the driver circuit drives the plasma display panel by one of 3D drive for displaying a 3D image on the plasma display panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and the left-eye image signal, and the 2D image is displayed based on a 2D image signal; and
a control signal generation circuit, wherein
the control signal generation circuit determines which of the 2D image signal and the 3D image signal is input based on an input signal,
the control signal generation circuit generates a control signal and a shutter opening/closing timing signal, the control signal controlling the driver circuit in order to display the 2D image or the 3D image on the plasma display panel based on the determination result, the shutter opening/closing timing signal including:
a right-eye timing signal that becomes ON when the right-eye field of the 3D image is displayed on the plasma display panel and becomes OFF when the left-eye field is displayed; and
a left-eye timing signal that becomes ON when the left-eye field of the 3D image is displayed and becomes OFF when the right-eye field is displayed,
wherein the driver circuit sets a gradient of the up-ramp waveform voltage in the all-cell initializing period during the 3D drive to be steeper than a gradient of the up-ramp waveform voltage in the all-cell initializing period during the 2D drive, and
wherein the control signal generation circuit generates the shutter opening/closing timing signal where both of the right-eye timing signal and left-eye timing signal are OFF in the all-cell initializing period during the 3D drive.

2. A plasma display apparatus comprising:
a plasma display panel having a plurality of discharge cells each of which includes a display electrode pair formed of a scan electrode and a sustain electrode;
a driver circuit, wherein
the driver circuit forms one field using a plurality of subfields each of which has an initializing period, an address period, and a sustain period,
the driver circuit sets, as a first subfield of one field, an all-cell initializing subfield having an all-cell initializing period in which an increasing up-ramp waveform voltage and a decreasing down-ramp waveform voltage are applied to the scan electrode in the initializing period, and
the driver circuit drives the plasma display panel by one of 3D drive for displaying a 3D image on the plasma display panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and the left-eye image signal, and the 2D image is displayed based on a 2D image signal; and
a control signal generation circuit, wherein
the control signal generation circuit determines which of the 2D image signal and the 3D image signal is input based on an input signal,
the control signal generation circuit generates a control signal and a shutter opening/closing timing signal, the control signal controlling the driver circuit in order to display the 2D image or the 3D image on the plasma display panel based on the determination result, the shutter opening/closing timing signal including:
a right-eye timing signal that becomes ON when the right-eye field of the 3D image is displayed on the plasma display panel and becomes OFF when the left-eye field is displayed; and
a left-eye timing signal that becomes ON when the left-eye field of the 3D image is displayed and becomes OFF when the right-eye field is displayed,
wherein the driver circuit sets a gradient of the down-ramp waveform voltage in the all-cell initializing period during the 3D drive to be steeper than a gradient of the down-ramp waveform voltage in the all-cell initializing period during the 2D drive, and
wherein the control signal generation circuit generates the shutter opening/closing timing signal where both of the right-eye timing signal and left-eye timing signal are OFF in the all-cell initializing period during the 3D drive.

3. A plasma display apparatus comprising:
a plasma display panel having a plurality of discharge cells each of which includes a display electrode pair formed of a scan electrode and a sustain electrode;
a driver circuit, wherein
the driver circuit forms one field using a plurality of subfields each of which has an initializing period, an address period, and a sustain period,
the driver circuit sets, as a first subfield of one field, an all-cell initializing subfield having an all-cell initializing period in which an increasing up-ramp waveform voltage and a decreasing down-ramp waveform voltage are applied to the scan electrode in the initializing period, and
the driver circuit drives the plasma display panel by one of 3D drive for displaying a 3D image on the plasma display panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and the left-eye image signal, and the 2D image is displayed based on a 2D image signal; and
a control signal generation circuit, wherein
the control signal generation circuit determines which of the 2D image signal and the 3D image signal is input based on an input signal,
the control signal generation circuit generates a control signal and a shutter opening/closing timing signal, the control signal controlling the driver circuit in order to display the 2D image or the 3D image on the plasma display panel based on the determination result, the shutter opening/closing timing signal including:
a right-eye timing signal that becomes ON when the right-eye field of the 3D image is displayed on the plasma display panel and becomes OFF when the left-eye field is displayed; and
a left-eye timing signal that becomes ON when the left-eye field of the 3D image is displayed and becomes OFF when the right-eye field is displayed,
wherein the driver circuit sets a gradient of the up-ramp waveform voltage in the all-cell initializing period during the 3D drive to be steeper than a gradient of the up-ramp waveform voltage in the all-cell initializing period during the 2D drive, and the driver circuit sets a gradient of the down-ramp waveform voltage in the all-cell initializing period during the 3D drive to be steeper than a gradient of the down-ramp waveform voltage in the all-cell initializing period during the 2D drive, and
wherein the control signal generation circuit generates the shutter opening/closing timing signal where both of the right-eye timing signal and left-eye timing signal are OFF in the all-cell initializing period during the 3D drive.

4. A plasma display system comprising:
a plasma display apparatus including:
a plasma display panel having a plurality of discharge cells each of which includes a display electrode pair formed of a scan electrode and a sustain electrode;
a driver circuit, wherein
the driver circuit forms one field using a plurality of subfields each of which has an initializing period, an address period, and a sustain period,
the driver circuit sets, as a first subfield of one field, an all-cell initializing subfield having an all-cell initializing period in which an increasing up-ramp waveform voltage and a decreasing down-ramp waveform voltage are applied to the scan electrode in the initializing period, and
the driver circuit drives the plasma display panel by one of 3D drive for displaying a 3D image on the plasma display panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and the left-eye image signal, and the 2D image is displayed based on a 2D image signal; and
a control signal generation circuit, wherein
the control signal generation circuit determines which of the 2D image signal and the 3D image signal is input based on an input signal,
the control signal generation circuit generates a control signal and a shutter opening/closing timing signal, the control signal controlling the driver circuit in order to display the 2D image or the 3D image on the plasma display panel based on the determination result, the shutter opening/closing timing signal including:
a right-eye timing signal that becomes ON when the right-eye field of the 3D image is displayed on the plasma display panel and becomes OFF when the left-eye field is displayed; and
a left-eye timing signal that becomes ON when the left-eye field of the 3D image is displayed and becomes OFF when the right-eye field is displayed; and
shutter glasses including a right-eye shutter and a left-eye shutter that can be independently opened or closed, and controlling the opening/closing of the shutters in response to the shutter opening/closing timing signal generated by the control signal generation circuit,
wherein the driver circuit sets a gradient of at least one of the up-ramp waveform voltage and the down-ramp waveform voltage in the all-cell initializing period during the 3D drive to be steeper than a gradient of the one waveform voltage in the all-cell initializing period during the 2D drive, and
wherein the control signal generation circuit generates the shutter opening/closing timing signal where both of the right-eye shutter and left-eye shutter are closed in the all-cell initializing period during the 3D drive.

5. A driving method of a plasma display panel having a plurality of discharge cells each of which includes a display electrode pair formed of a scan electrode and a sustain electrode, the driving method comprising:
forming one field using a plurality of subfields each of which has an initializing period, an address period, and a sustain period;
setting, as a first subfield of one field, an all-cell initializing subfield having an all-cell initializing period in which an increasing up-ramp waveform voltage and a decreasing down-ramp waveform voltage are applied to the scan electrode in the initializing period;
driving the plasma display panel by one of 3D drive for displaying a 3D image on the plasma display panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and the left-eye image signal, and the 2D image is displayed based on a 2D image signal; and
setting a gradient of at least one of the up-ramp waveform voltage and the down-ramp waveform voltage in the all-cell initializing period during the 3D drive to be steeper than a gradient of the one waveform voltage in the all-cell initializing period during the 2D drive.

6. A control method of shutter glasses for a plasma display apparatus, the control method comprising:
controlling the shutter glasses so that both of a right-eye shutter and a left-eye shutter are closed in an all-cell initializing period during 3D drive,
wherein the shutter glasses are used for viewing an image displayed on the plasma display apparatus and have the right-eye shutter and the left-eye shutter capable of being independently opened or closed,
wherein the plasma display apparatus includes:
a plasma display panel having a plurality of discharge cells each of which includes a display electrode pair formed of a scan electrode and a sustain electrode;
a driver circuit, wherein
the driver circuit forms one field using a plurality of subfields each of which has an initializing period, an address period, and a sustain period,
the driver circuit sets, as a first subfield of one field, an all-cell initializing subfield having the all-cell initializing period in which an increasing up-ramp waveform voltage and a decreasing down-ramp waveform voltage are applied to the scan electrode in the initializing period, and
the driver circuit drives the plasma display panel by one of 3D drive for displaying a 3D image on the plasma display panel and 2D drive for displaying a 2D image on the plasma display panel, wherein the 3D image is displayed by alternately repeating a right-eye field for displaying a right-eye image signal and a left-eye field for displaying a left-eye image signal based on a 3D image signal having the right-eye image signal and the left-eye image signal, and the 2D image is displayed based on a 2D image signal; and
a control signal generation circuit, wherein
the control signal generation circuit determines which of the 2D image signal and the 3D image signal is input based on an input signal,
the control signal generation circuit generates a control signal and a shutter opening/closing timing signal, the control signal controlling the driver circuit in order to display the 2D image or the 3D image on the plasma display panel based on the determination result, the shutter opening/closing timing signal including:
a right-eye timing signal that becomes ON when the right-eye field of the 3D image is displayed on the plasma display panel and becomes OFF when the left-eye field is displayed; and
a left-eye timing signal that becomes ON when the left-eye field of the 3D image is displayed and becomes OFF when the right-eye field is displayed, and
wherein the driver circuit sets a gradient of at least one of the up-ramp waveform voltage and the down-ramp waveform voltage in the all-cell initializing period during the 3D drive to be steeper than a gradient of the one waveform voltage in the all-cell initializing period during the 2D drive.
